(19) United States
(12) Patent Application Publication
(10) Pub. No.: US 2025/0276528 A1
(43) Pub. Date: Sep. 4, 2025

(54) LIQUID EJECTION APPARATUS AND ADJUSTMENT METHOD FOR LIQUID EJECTION APPARATUS

(71) Applicant: CANON KABUSHIKI KAISHA, Tokyo (JP)

(72) Inventors: TAKATSUGU MORIYA, Tokyo (JP); SHUZO IWANAGA, Kanagawa (JP); KEIJI TOMIZAWA, Kanagawa (JP)

(21) Appl. No.: 19/042,364

(22) Filed: Jan. 31, 2025

(30) Foreign Application Priority Data
Mar. 4, 2024 (JP) 2024-031812

(51) Int. Cl. B41J 2/175; B41J 2/18; B41J 2/195; B41J 11/00; B41J 29/393

(52) U.S. Cl. CPC B41J 2/17596; B41J 2/18; B41J 2/195; B41J 11/0095; B41J 29/393; B41J 2029/3935

(57) ABSTRACT

Provided is a liquid ejection apparatus including: a liquid ejection head having an ejection port and an ejection element configured to eject a liquid from the ejection port; a circulation pump configured to circulate the liquid to be supplied to the ejection port; an evaluation unit configured to change an output of the circulation pump and evaluate an ejection state in which the liquid is ejected from the ejection port by the ejection element; and a setting unit configured to set the output of the circulation pump based on a result of the evaluation of the ejection state by the evaluation unit.

### BACKGROUND OF THE INVENTION

### Field of the Invention

The present disclosure relates to a liquid ejection apparatus and an adjustment method for a liquid ejection apparatus.

### Description of the Related Art

An inkjet printing apparatus, which is one example of a liquid ejection apparatus, is equipped with liquid ejection heads that eject liquids, such as inks, from ejection ports. There are liquid ejection heads that have a circulation channel for circulating the ink to be supplied to the ejection ports. Circulating the ink to be supplied to the ejection ports with a pump or the like prevents inclusion of foreign substances, increase in the ink due to evaporation and the like, and lowers the likelihood of clogging of the ejection ports and the like by the high-viscosity ink.

Japanese Patent Laid-Open No. 2020-196164 discloses a liquid ejection apparatus provided with a circulation channel through which to circulate a liquid (ink) to be supplied to a liquid ejection head, pumps which cause the liquid to circulate through the circulation channel, and pressure sensors which detect pressures in the circulation channel. The liquid can be stably circulated by controlling the pumps based on the pressures detected by the pressure sensors.

However, with the configuration in which the pressure sensors are installed in the liquid circulation channel, it is difficult to downsize the liquid ejection head.

### SUMMARY OF THE INVENTION

A liquid ejection apparatus according to an aspect of the present disclosure includes: a liquid ejection head having an ejection port and an ejection element configured to eject a liquid from the ejection port; a circulation pump configured to circulate the liquid to be supplied to the ejection port; an evaluation unit configured to change an output of the circulation pump and evaluate an ejection state in which the liquid is ejected from the ejection port by the ejection element; and a setting unit configured to set the output of the circulation pump based on a result of the evaluation of the ejection state by the evaluation unit.

Further features of the present invention will become apparent from the following description of exemplary embodiments with reference to the attached drawings.

### BRIEF DESCRIPTION OF THE DRAWINGS

FIG. 1 is a schematic view illustrating an inkjet printing apparatus;

FIG. 2 is a plan view illustrating the surface of a printing element substrate on a side where ejection ports are formed;

FIG. 3 is an enlarged view of the portion surrounded by the frame A in FIG. 2;

FIG. 4 is a plan view illustrating the surface of the printing element substrate on the opposite side from the side where the ejection ports are formed;

FIG. 5 is a block diagram illustrating a hardware configuration of the inkjet printing apparatus;

FIG. 6 is a block diagram illustrating a functional configuration of the inkjet printing apparatus;

FIG. 7 is a flowchart illustrating steps in a pump adjustment mode;

FIGS. 8A and 8B are schematic views of an evaluation pattern;

FIG. 9 is a graph illustrating a relationship between the output of a circulation pump and the circulatory flow velocity of an ink;

FIG. 10 is a schematic view illustrating a modification of the inkjet printing apparatus;

FIG. 11 is a flowchart illustrating steps in a pump adjustment mode;

FIG. 12 is a schematic view a light source and an optical sensor;

FIG. 13 is a plan view illustrating a positional relationship between a temperature detection element and a heater;

FIG. 14 is a cross-sectional view taken along the line XIV-XIV in FIG. 13;

FIG. 15 is a graph illustrating a temperature profile during normal ejection and a temperature profile during ejection failure;

FIG. 16 is a flowchart illustrating steps in a pump adjustment mode; and

FIG. 17 is a flowchart illustrating steps in a pump adjustment mode.

### DESCRIPTION OF THE EMBODIMENTS

Preferred embodiments of the present disclosure will be specifically described below with reference to the accompanying drawings. The following description will be given taking an inkjet printing apparatus as an example of a liquid ejection apparatus. Here, the inkjet printing apparatus may be, for example, a single-function printer having only a printing function or a multi-function printer having multiple functions such as a printing function, a fax function, and a scanner function. Alternatively, the liquid ejection apparatus is not limited to an inkjet printing apparatus and may be, for example, a manufacturing apparatus for manufacturing a color filter, an electronic device, an optical device, a microscopic structure, or the like by an inkjet printing method.

Note that in the following description, “printing” not only includes formation of information with a meaning, such as letters and/or a figure, but also formation of information with no meaning. Moreover, “printing” is not limited by whether what is to be “printed” is elicited so as to be visually perceptible to humans, and represents formation of an image, a design, a pattern, a structure, or the like on a print medium and also processing a print medium.

A “print medium” represents not only paper used in general printing apparatuses but also things that can receive inks such as cloth, plastic films, sheet metal, glass, ceramic, resin, wood, and leather.

Further, an “ink” should be interpreted broadly, as with the above-mentioned definition of “printing.” Thus, an “ink” represents a liquid that is applied onto a print medium for formation of an image, a design, a pattern, or the like, processing of the print medium, or processing of the ink (e.g., solidification or insolubilization of the color material in the ink applied onto the print medium).

A “printing element” collectively represents an ejection port for an ink, fluid paths communicating with the ejection port, and an ejection element that generates an energy to be used to eject the ink, unless otherwise noted. A “printing element” may also be referred to as “nozzle.”

### First Embodiment

### Configuration of Inkjet Printing Apparatus

Inkjet printing apparatuses include a serial-type printing apparatus that performs printing by alternately moving a liquid ejection head and conveying a print medium, and a line-type printing apparatus that performs printing by conveying a print medium while holding a liquid ejection head at a fixed position. The present embodiment is applicable to both the serial-type printing apparatus and the line-type printing apparatus.

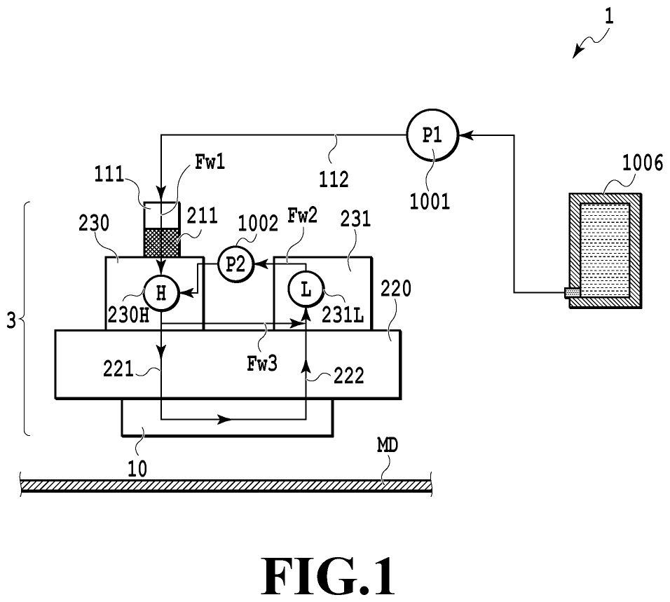

FIG. 1 is a schematic view illustrating an inkjet printing apparatus 1 equipped with serial-type heads. In FIG. 1, a supply channel Fw1 and a circulation channel Fw2 for an ink in the inkjet printing apparatus 1 are illustrated. Note that, in order to be able to perform full-color printing with inks of four colors of cyan (C), magenta (M), yellow (Y), and black (K), a supply channel and a circulation channel are provided for each of the inks of the four colors. In the present embodiment, the supply channel and the circulation channel for the ink of one of the four colors will be described in order to simply the description.

As illustrated in FIG. 1, the inkjet printing apparatus 1 according to the first embodiment includes a main tank 1006, a liquid ejection head 3, a supply pump 1001 (P1), and a circulation pump 1002 (P2). The supply pump 1001 is provided on an ink supply tube 112 connecting to the main tank 1006 and a liquid connection part 111 of the liquid ejection head 3. The supply pump 1001 supplies the ink stored in the main tank 1006 to the liquid ejection head 3 through the ink supply tube 112 and the liquid connection part 111.

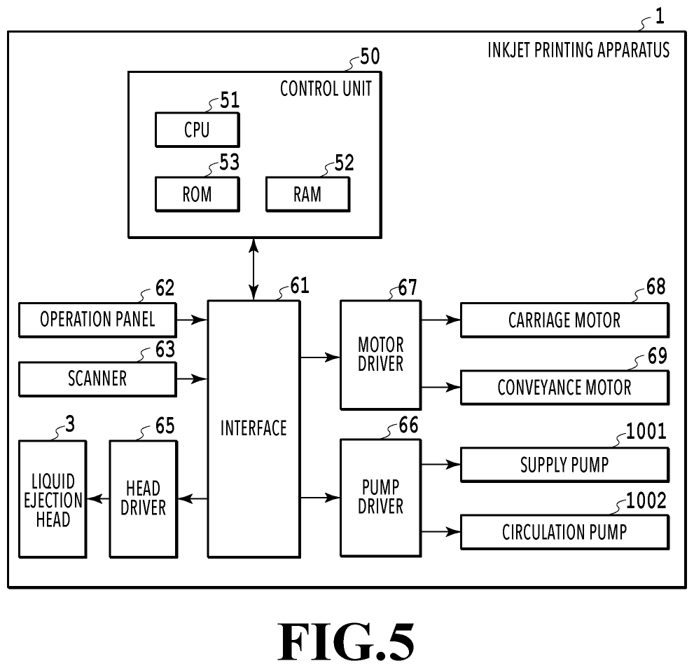

The liquid ejection head 3 is detachably mounted on a carriage (not illustrated). The carriage on which the liquid ejection head 3 is mounted is reciprocally moved by a carriage motor 68 (see FIG. 5) and a guide shaft (not illustrated) in a main scanning direction (e.g., the width direction of a print medium MD). The print medium MD is conveyed by a conveyance motor 69 (see FIG. 5) and conveyance rollers (not illustrated) in a sub scanning direction crossing the main scanning direction, in particular, crossing perpendicularly to the main scanning direction. The inkjet printing apparatus 1 performs printing on the print medium MD by causing the liquid ejection head 3 to eject the ink while alternately moving the liquid ejection head 3 (carriage) and conveying the print medium.

The liquid ejection head 3 has a filter 211, a first negative pressure control unit 230 on a higher pressure side, a second negative pressure control unit 231 on a lower pressure side, a liquid supply unit 220, and a printing element substrate 10. The filter 211 is disposed between the liquid connection part 111 and the first negative pressure control unit 230. The first negative pressure control unit 230 has a first pressure control chamber 230H and a pressure adjustment mechanism (not illustrated) on the higher pressure side. The first pressure control chamber 230H is connected to the liquid connection part 111 (filter 211) and to a common supply channel 221 formed in the liquid supply unit 220. The first negative pressure control unit 230 controls the pressure on the ink flowing through the first pressure control chamber 230H to a pressure lower than the pressure on the ink flowing upstream of the first pressure control chamber 230H with the pressure adjustment mechanism.

The second negative pressure control unit 231 has a second pressure control chamber 231L and a pressure adjustment mechanism (not illustrated) on the lower pressure side. The second pressure control chamber 231L is connected to the circulation pump 1002 and to a common collection channel 222 formed in the liquid supply unit 220. The second negative pressure control unit 231 controls the pressure on the ink flowing through the second pressure control chamber 231L to a pressure lower than the pressure on the ink flowing through the first pressure control chamber 230H with the pressure adjustment mechanism.

The circulation pump 1002 sends the ink having flowed into the second negative pressure control unit 231 (second pressure control chamber 231L) to the first negative pressure control unit 230 (first pressure control chamber 230H). The circulation pump 1002 is provided to the liquid ejection head 3. The circulation pump 1002 is desirably smaller in size and light in weight in order to smoothly move the liquid ejection head 3 (carriage). For example, the circulation pump 1002 may be constructed using a piezoelectric pump, a tube pump, or a small diaphragm pump.

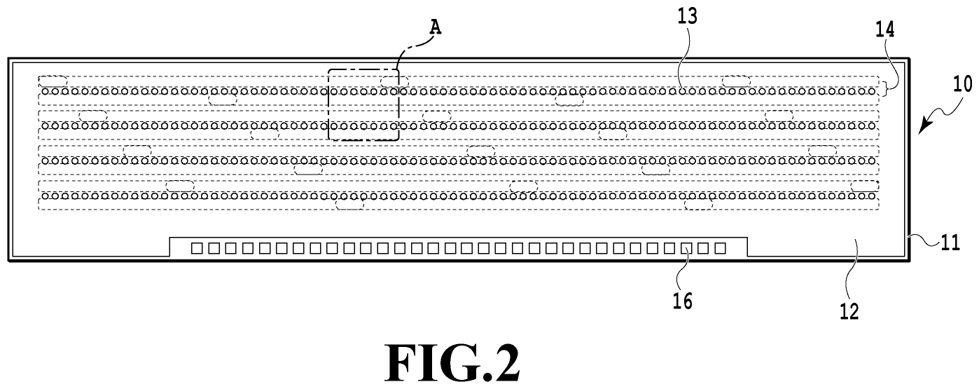

The ink stored in the main tank 1006 is supplied to the liquid ejection head 3 by the supply pump 1001 through the ink supply tube 112 and the liquid connection part 111. After passing through the liquid connection part 111, the ink flows through the filter 211 and the first negative pressure control unit 230 (first pressure control chamber 230H) into the common supply channel 221 in the liquid supply unit 220 and is supplied to the printing element substrate 10, which has ejection ports 13 (see FIG. 2). In this way, the supply channel Fw1 is formed, which is connected to the main tank 1006 and the printing element substrate 10 of the liquid ejection head 3 and through which the ink to be supplied to the ejection ports 13 in the printing element substrate 10 flows. Note that the supply channel Fw1 includes the ink supply tube 112, the liquid connection part 111, the filter 211, the first pressure control chamber 230H, and the common supply channel 221 in the liquid supply unit 220.

Part of the ink supplied to the ejection ports 13 in the printing element substrate 10 is ejected from the ejection ports 13. The ink that has not been ejected from the ejection ports 13 is caused to flow through the common collection channel 222 in the liquid supply unit 220 into the second negative pressure control unit 231 (second pressure control chamber 231L) by the pressure difference between the first negative pressure control unit 230 and the second negative pressure control unit 231. The ink having flowed into the second negative pressure control unit 231 (second pressure control chamber 231L) is returned to the first negative pressure control unit 230 (first pressure control chamber 230H) by the circulation pump 1002. Thus, the circulation channel Fw2, through which the ink circulating by means of the circulation pump 1002 flows, is formed in the liquid ejection head 3. Note that the circulation channel Fw2 includes the common supply channel 221 and the common collection channel 222 in the liquid supply unit 220, the first negative pressure control unit 230, and the first pressure control chamber 230H.

Also, a bypass channel Fw3 connected to the first negative pressure control unit 230 and the second negative pressure control unit 231 is formed on the circulation channel Fw2 in the liquid ejection head 3. Part of the ink returned to the first negative pressure control unit 230 does not flow through the liquid supply unit 220 and the printing element substrate 10 but flows through the bypass channel Fw3 into the second negative pressure control unit 231. In this way, in a case where the output of the circulation pump 1002 is so large that the amount of the ink returned to the first negative pressure control unit 230 is greater than the amount of the ink flowing into the printing element substrate 10, the shortage of the ink at the second negative pressure control unit 231 will be supplemented. The bypass channel Fw3 is provided with a check valve (not illustrated). With the check valve, the ink in the bypass channel Fw3 flows only in the direction from the first negative pressure control unit 230 toward the second negative pressure control unit 231.

### Configuration of Printing Element Substrate

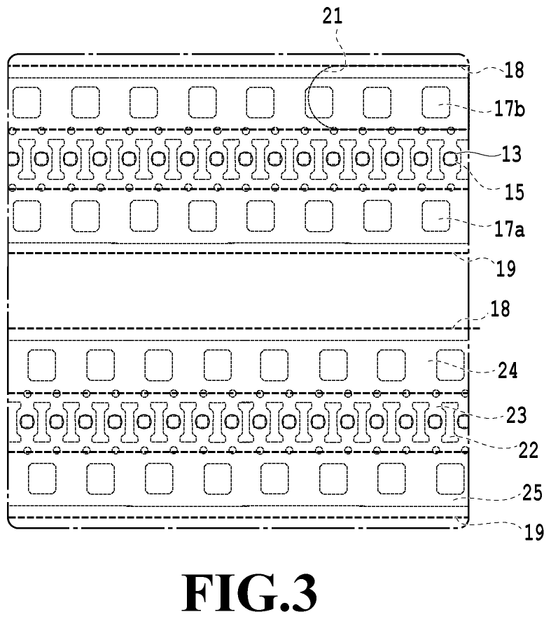

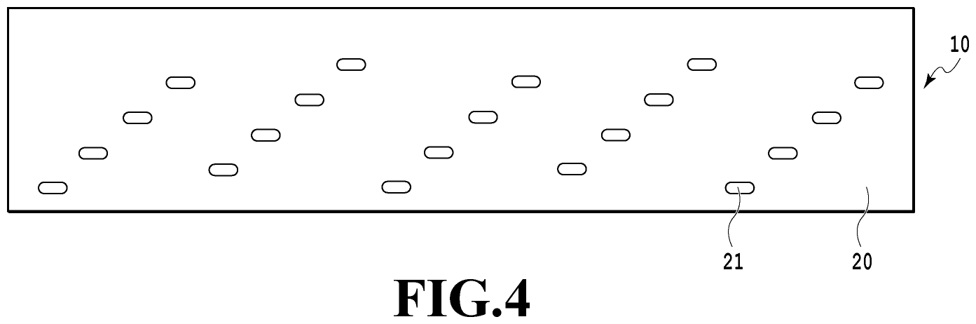

FIG. 2 is a plan view illustrating the surface of the printing element substrate 10 on the side where the ejection ports 13 are formed. FIG. 3 is an enlarged view of the portion surrounded by the frame A in FIG. 2. FIG. 4 is a plan view illustrating the surface of the printing element substrate 10 on the opposite side from the side where the ejection ports 13 are formed. As illustrated in FIGS. 2 to 4, the printing element substrate 10 includes a substrate 11, an ejection port forming member 12, and a lid member 20. As illustrated in FIG. 2, the substrate 11 is formed in a rectangular plate shape with silicon (Si).

As illustrated in FIG. 2, the ejection port forming member 12 is formed on the surface of the substrate 11 on one side with a photosensitive resin material or the like. Four ejection port arrays 14 each corresponding to one of the inks of the four colors are formed in the ejection port forming member 12. Each ejection port array 14 includes multiple ejection ports 13 arrayed in the longitudinal direction of the ejection port forming member 12. The direction of extension of the ejection port arrays 14 each being multiple arrayed ejection ports 13 will be hereinafter referred to as “ejection port array direction.”

As illustrated in FIG. 3, heaters 15 are disposed at portions of the substrate 11 respectively corresponding to the ejection ports 13. The heaters 15 are heating elements for generating bubbles in the ink with a thermal energy. In other words, the heaters 15 are ejection elements for ejecting the ink from the ejection ports 13. Partitions 22 formed between the ejection port forming member 12 and the substrate 11 define pressure chambers 23 communicating with the ejection ports 13 and adjoining the heaters 15. Each heater 15 is electrically connected to terminal 16 illustrated in FIG. 2 by an electric wiring (not illustrated) provided in the printing element substrate 10. The heater 15 generates heat based on a pulse signal input from a control unit 50 (see FIG. 5) of the inkjet printing apparatus 1 through an electric wiring substrate (not illustrated) and a flexible wiring substrate (not illustrated) to thereby boil the ink. The heater 15 ejects the ink from the ejection ports 13 with the force of bubbles generated by this boiling.

Also, supply-side common liquid chambers 24 and collection-side common liquid chambers 25 are formed between the ejection port forming member 12 and the substrate 11. the supply-side common liquid chambers 24 and the collection-side common liquid chambers 25 extend in the ejection port array direction on both sides of each ejection port array 14. The ejection ports 13 communicate with the supply-side common liquid chambers 24 and the collection-side common liquid chambers 25 through the pressure chambers 23. The supply-side common liquid chambers 24 communicate with liquid supply paths 18 on the lid member 20 side through supply ports 17a formed in the substrate 11. The collection-side common liquid chamber 25 communicate with liquid collection paths 19 on the lid member 20 side through collection ports 17b formed in the substrate 11.

As illustrated in FIG. 4, the lid member 20 is formed of silicon (Si) in a thin rectangular plate shape corresponding to the shape of the outer periphery of the substrate 11. The lid member 20 is bonded to the surface of the substrate 11 on the opposite side from the ejection port forming member 12. The liquid supply paths 18 and the liquid collection paths 19 are formed between the lid member 20 and the substrate 11 (see FIG. 3). As illustrated in FIG. 3, the liquid supply paths 18 and the liquid collection paths 19 extend in the ejection port array direction in alignment with the supply-side common liquid chambers 24 and the collection-side common liquid chambers 25, respectively. The lid member 20 functions as a lid that forms some of the walls of the liquid supply paths 18 and the liquid collection paths 19. Note that grooves that form the liquid supply paths 18 and the liquid collection paths 19 are formed in the surface of the substrate 11 facing the lid member 20.

As illustrated in FIG. 4, multiple openings 21 each communicating with a liquid supply path 18 or a liquid collection path 19 are formed in the lid member 20. In the present embodiment, three openings 21 are provided per liquid supply path 18, and two openings 21 are provided per liquid collection path 19. The lid member 20 desirably has sufficient corrosion resistance against inks. Also, the opening shape and opening positions of the openings 21 are required to be highly accurate in order to prevent mixing of the colors. For this reason, it is desirable to form the multiple openings 21 in the lid member 20 by a photolithography process using a photosensitive resin material. Also, considering the pressure loss, the thickness of the lid member 20 is desirably small. Hence, the lid member 20 is desirably formed in a film shape.

Next, a flow of the ink inside the printing element substrate 10 will be described. The ink having flowed through the common supply channel 221 in the liquid supply unit 220 flows into the liquid supply paths 18 through the openings 21 in the lid member 20 of the printing element substrate 10. The ink having flowed into the liquid supply paths 18 flows through the supply ports 17a and the supply-side common liquid chambers 24 into the pressure chambers 23. Part of the ink having flowed into the pressure chamber 23 is ejected from the ejection ports 13 in response to actuation of the heaters 15. The ink that has flowed into the pressure chambers 23 but has not been ejected from the ejection ports 13 flows through the collection-side common liquid chambers 25 and the collection ports 17b into the liquid collection paths 19. The ink having flowed into the liquid collection paths 19 flows into the common collection channel 222 in the liquid supply unit 220 through the opening 21 in the lid member 20.

In the inkjet printing apparatus 1 according to the first embodiment, the ink can be circulated so as to pass through the pressure chambers 23 in the liquid ejection head 3 by driving the circulation pump 1002. Hence, in a case of performing printing on a print medium MD by ejecting the ink from ejection ports 13 in the liquid ejection head 3, ink flows will be generated also at ejection ports 13 and pressure chambers 23 that are set not to eject the ink. This prevents increase in the viscosity of the ink in the ejection ports 13 and the pressure chambers 23 that are set not to eject the ink. The liquid ejection head 3 is therefore capable of performing high-quality printing at high speed on the print medium MD.

In a case where the ink having passed through the pressure chambers 23 does not normally circulate through the circulation channel Fw2, sufficient ink flows will not be generated at the ejection ports 13 and the pressure chambers 23, so that the viscosity of the ink in the ejection ports 13 and the pressure chambers 23 will rise. The rise in the viscosity of the ink will make it difficult for the ink to be ejected from the ejection ports 13 in response to actuation of the heaters 15. Consequently, the ejection velocity of droplets ejected from the ejection ports 13, the volume of the droplets, and the like may change. Further, the rise in the viscosity of the ink may lead to a failure to eject the ink from the ejection ports 13 in response to actuation of the heaters 15. Consequently, performing printing on a print medium MD may result in troubles such as a decrease in the printing density on the print medium MD and a shift in the printing position on the print medium MD, for example.

Examples of the causes of the failure to normally circulate the ink through the circulation channel Fw2 after passing through the pressure chambers 23 include deterioration of the circulation pump 1002, clogging of the circulation channel Fw2 by bubbles, a foreign substance, and/or the like, an abnormal increase in the viscosity of the ink, and so on. While the circulation pump 1002 is constructed using a piezoelectric pump, a tube pump, a diaphragm pump, or the like, the circulation pump 1002 gradually deteriorates with continued use. As the circulation pump 1002 deteriorates, the amount of the ink to be circulated through the circulation channel Fw2 decreases, so that the ink flows at the ejection ports 13 and the pressure chambers 23 are not sufficient. Consequently, the viscosity of the ink in the ejection ports 13 and the pressure chambers 23 will rise. This will result in, for example, troubles as mentioned earlier in a case of performing printing on a print medium MD.

The viscosity of the ink also rises in a case where the ambient environment of the inkjet printing apparatus 1 changes, e.g., in a case where the environmental temperature drops. Thus, if the ambient environment of the inkjet printing apparatus 1 changes, the flow velocity of the ink circulating through the circulation channel Fw2 will be insufficient with the output of the circulation pump 1002 in the previous environment, and troubles as mentioned earlier may occur in a case of performing printing on a print medium MD, for example. For this reason, before the inkjet printing apparatus 1 performs printing on the print medium MD, the output of the circulation pump 1002 needs to be set so as to normally circulate the ink. In the present embodiment, a configuration capable of performing proper ink circulation while also allowing downsizing of the liquid ejection head 3 will be described.

### Configuration of Control Unit

FIG. 5 is a block diagram illustrating a hardware configuration of the inkjet printing apparatus 1. As illustrated in FIG. 5, the inkjet printing apparatus 1 according to the first embodiment further includes the control unit 50, an interface 61, an operation panel 62, a scanner 63, a head driver 65, a pump driver 66, and a motor driver 67. The control unit 50 has a central processing unit (CPU) 51, a random access memory (RAM) 52, and a read only memory (ROM) 53. The CPU 51 functions as a control unit that controls the operation of components of the inkjet printing apparatus 1 based on programs, such as process procedures, stored in the ROM 53. The RAM 52 is used as a work area or the like for the CPU 51 to execute processes. The ROM 53 stores the programs to be executed by the CPU 51 and various data necessary for the inkjet printing apparatus 1 to operate.

The control unit 50 is electrically connected the operation panel 62, the scanner 63, the head driver 65, the pump driver 66, and the motor driver 67 through the interface 61. The interface 61 receives image data sent from an external host apparatus (not illustrated) and sends it to the control unit 50. The CPU 51 controls the head driver 65 based on the image data sent from the external host apparatus to control the actuation of the heaters 15 (ejection elements) provided in the liquid ejection head 3. Moreover, the CPU 51 controls the pump driver 66 to control the actuation of the supply pump 1001 and the circulation pump 1002. The CPU 51 controls the motor driver 67 to control the actuation of the carriage motor 68 and the conveyance motor 69.

Also, the operation panel 62 sends input data input by operations on the operation panel 62 to the control unit 50 through the interface 61. The scanner 63 is disposed near the downstream side of the liquid ejection head 3 in the conveyance direction of a print medium MD (sub scanning direction). The scanner 63 reads a surface of the print medium MD subjected to printing by the liquid ejection head 3 and obtains the result of the scan electronic image data. The scanner 63 sends the obtained image data to the control unit 50 through the interface 61.

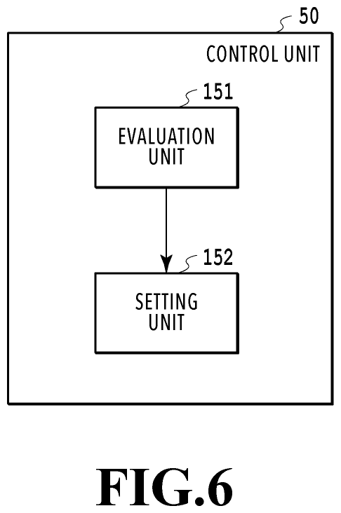

FIG. 6 is a block diagram illustrating a functional configuration of the control unit 50 in the inkjet printing apparatus 1. The control unit 50 has an evaluation unit 151 and a setting unit 152. These functions are implemented by the CPU 51 of the control unit 50 executing programs stored in the ROM 53. Thus, the CPU 51 can be regarded as having each of the functions of the control unit 50 illustrated in FIG. 6, but does not need to have all of these functions. For example, the control unit 50 may include a dedicated processing circuit that performs a process corresponding to at least one of the functions of the control unit 50. Also, in the present embodiment, information may be exchanged between the functions of the control unit 50 through the RAM 52.

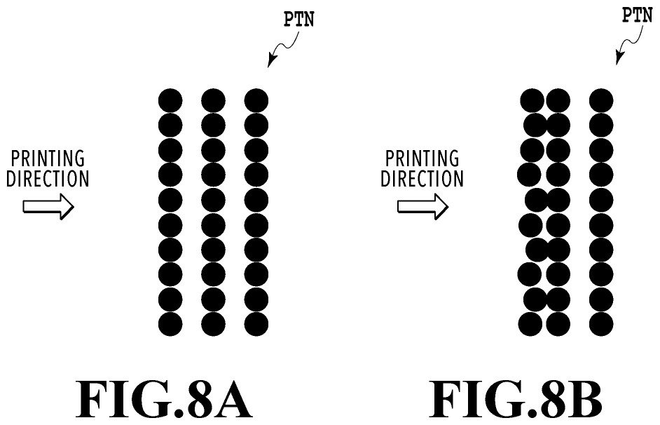

The evaluation unit 151 changes the output of the circulation pump 1002 and evaluates the state of ejection of the ink from the ejection ports 13 by the heaters 15 (ejection elements). In the present embodiment, the state of ejection of the ink from the ejection ports 13 by the heaters 15 will be referred to as “ink ejection state.” In the present embodiment, the evaluation unit 151 evaluates the ink ejection state based on an evaluation pattern PTN (see FIGS. 8A and 8B) printed on a print medium MD by ejecting the ink from the ejection ports 13. For example, the evaluation unit 151 evaluates the ink ejection state based on image data of the evaluation pattern PTN read by the scanner 63.

The evaluation unit 151 changes the output of the circulation pump 1002 by changing a parameter which can change the flow rate of the ink to be sent by the circulation pump 1002. For example, in a case where the circulation pump 1002 is constructed using a piezoelectric pump, the evaluation unit 151 changes the output of the circulation pump 1002 by changing the driving voltage or driving frequency for the piezoelectric element included in the piezoelectric pump. In a case where the circulation pump 1002 is constructed using a tube pump, the evaluation unit 151 changes the output of the circulation pump 1002 by changing the number of times to rotate the rollers included in the tube pump. Note that the rollers in the tube pump rotate in such a way as to press the tube in the tube pump to send the ink.

The setting unit 152 sets the output of the circulation pump 1002 based on the result of the evaluation of the ink ejection state by the evaluation unit 151. For example, based on the result of the evaluation of the ink ejection state by the evaluation unit 151, the setting unit 152 sets the output of the circulation pump 1002 to an output with which the ink can be normally ejected from the ejection ports 13. Incidentally, in the case where the circulation pump 1002 is constructed using a piezoelectric pump, the setting unit 152 sets the output of the circulation pump 1002 by setting the driving voltage or driving frequency for the piezoelectric element included in the piezoelectric pump. In the case where the circulation pump 1002 is constructed using a tube pump, the setting unit 152 sets the output of the circulation pump 1002 by setting the number of times to rotate the rollers included in the tube pump.

### Adjustment Method for Inkjet Printing Apparatus

Next, an adjustment method for the inkjet printing apparatus 1 according to the first embodiment will be described as an adjustment method for a liquid ejection apparatus. In the present embodiment, a mode for setting the output of the circulation pump 1002 so as to normally circulate the ink before performing printing on a print medium MD will be referred to as “pump adjustment mode.” The control unit 50 performs control for transitioning to the pump adjustment mode in a case where printing is performed on a certain number of print media MD or a certain time period elapses.

Note that the control unit 50 may be configured to perform the control for transitioning to the pump adjustment mode in response to an operation on the operation panel 62 by the user. In this case, the operation panel 62 may send input data corresponding to the operation for transitioning to the pump adjustment mode to the control unit 50. Also, in this case, the pump adjustment mode may be part of a head diagnosis mode for detecting abnormalities of the liquid ejection head 3.

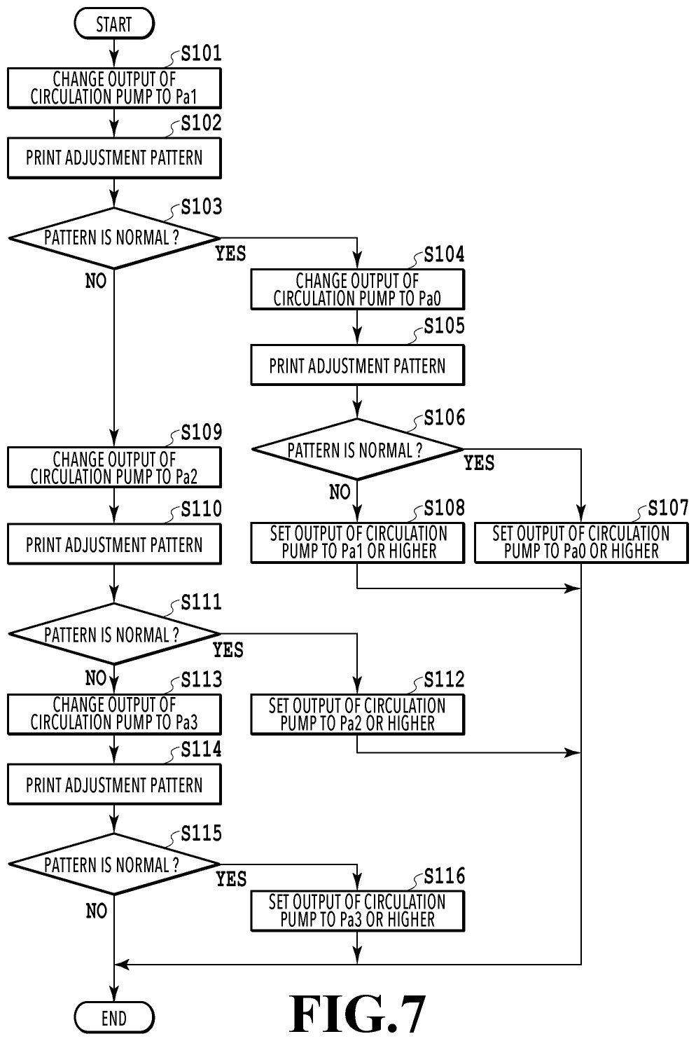

FIG. 7 is a flowchart illustrating steps in the pump adjustment mode according to the first embodiment. Note that the steps (processes) in the flowchart illustrated in FIG. 7 are executed by the CPU 51 executing a control program stored in the ROM 53 of the control unit 50.

First, in step S101, the evaluation unit 151 of the control unit 50 performs a process of changing the output of the circulation pump 1002 to any value Pa1. In doing so, the evaluation unit 151 controls the pump driver 66 to change the output of the circulation pump 1002 to Pa1. As a result, the ink is caused to circulate through the circulation channel Fw2 by the circulation pump 1002 whose output has been set to Pa1.

In step S102, the control unit 50 performs a process of printing the evaluation pattern PTN (see FIGS. 8A and 8B) on a print medium MD. In doing so, the CPU 51 of the control unit 50, for example, controls the head driver 65 based on image data of the evaluation pattern PTN stored in the ROM 53 to control the actuation of the heaters 15 (ejection elements) provided in the liquid ejection head 3. As a result, the liquid ejection head 3 ejects the ink from the ejection ports 13 by the actuation of the heaters 15 to print the evaluation pattern PTN on a print medium MD, for example. Also, at this time, the scanner 63 reads the evaluation pattern PTN on the print medium MD printed by the liquid ejection head 3 and obtains the result of the scan as electronic image data. The scanner 63 sends the obtained image data of the evaluation pattern PTN to the control unit 50.

FIGS. 8A and 8B are schematic views of the evaluation pattern PTN. FIG. 8A is a schematic view of the evaluation pattern PTN printed in a case where the ink normally circulates through the circulation channel Fw2. FIG. 8B is a schematic view of the evaluation pattern PTN printed in a case where the ink does not normally circulate through the circulation channel Fw2. Note that the black circles in FIGS. 8A and 8B represent dots formed by droplets that were ejected from ejection ports 13 in the liquid ejection head 3 and landed on a print medium. The bold arrows in FIGS. 8A and 8B represent the printing direction of the evaluation pattern PTN (main scanning direction).

As illustrated in FIG. 8A, in the case where the ink normally circulates through the circulation channel Fw2, the evaluation pattern PTN is printed at a predetermined printing position on the print medium MD in the first printing after the inkjet printing apparatus 1 has been inactive for a long time period. As illustrated in FIG. 8B, in the case where the ink does not normally circulate through the circulation channel Fw2, the printing position of the evaluation pattern PTN on the print medium MD gets shifted in the first printing after the inkjet printing apparatus 1 has been inactive for a long time period. By determining whether the evaluation pattern PTN printed on the print medium MD is normal or not, it is possible to evaluate whether the ink ejection state is such that the ink is normally ejected from the ejection port 13.

Referring back to FIG. 7, in step S103, the evaluation unit 151 of the control unit 50 determines whether the evaluation pattern PTN printed on the print medium MD is normal. For example, based on image data of the evaluation pattern PTN sent from the scanner 63, the evaluation unit 151 determines by image processing whether the evaluation pattern PTN is printed at the predetermined printing position on the print medium MD. The evaluation unit 151 may determine whether the evaluation pattern PTN is printed at the predetermined printing position on the print medium MD by comparing the image data sent from the scanner 63 and image data of a reference evaluation pattern PTN. The evaluation unit 151 determines that the evaluation pattern PTN printed on the print medium MD is normal in a case where the evaluation pattern PTN is printed at the predetermined printing position on the print medium MD. In other words, in the case where the evaluation pattern PTN is printed at the predetermined printing position on the print medium MD, the evaluation unit 151 evaluates that the ink ejection state is such that the ink is normally ejected from the ejection ports 13. On the other hand, in the case where the evaluation pattern PTN is not printed at the predetermined printing position on the print medium MD, the evaluation unit 151 evaluates that the ink ejection state is not such that the ink is normally ejected from the ejection ports 13.

The processing proceeds to step S104 if the evaluation unit 151 determines that the evaluation pattern PTN printed on the print medium MD is normal, i.e., the result of the determination in step S103 is YES. The processing proceeds to step S109 if the evaluation unit 151 determines that the evaluation pattern PTN printed on the print medium MD is not normal, i.e., the result of the determination in step S103 is NO.

In step S104, the evaluation unit 151 of the control unit 50 performs a process of changing the output of the circulation pump 1002 to Pa0 lower than Pal. In doing so, the evaluation unit 151 controls the pump driver 66 to change the output of the circulation pump 1002 to Pa0. As a result, the ink is caused to circulate through the circulation channel Fw2 by the circulation pump 1002 whose output has been changed from Pa1 to Pa0.

In step S105, as in step S102, the control unit 50 performs a process of printing the evaluation pattern PTN on a print medium MD. Also, at this time, the scanner 63 reads the evaluation pattern PTN on the print medium MD printed by the liquid ejection head 3 and obtains the result of the scan as electronic image data. The scanner 63 sends the obtained image data of the evaluation pattern PTN to the control unit 50.

In step S106, as in step S103, the evaluation unit 151 of the control unit 50 determines whether the evaluation pattern PTN printed on the print medium MD is normal. The processing proceeds to step S107 if the evaluation unit 151 determines that the evaluation pattern PTN printed on the print medium MD is normal, i.e., the result of the determination in step S106 is YES. The processing proceeds to step S108 if the evaluation unit 151 determines that the evaluation pattern PTN printed on the print medium MD is not normal, i.e., the result of the determination in step S106 is NO.

In step S107, the setting unit 152 of the control unit 50 performs a process of setting the output of the circulation pump 1002 to Pa0 or higher, and the processing ends. Since the result of the determination in the previous step S106 is YES, the ink can be caused to normally circulate through the circulation channel Fw2 by the circulation pump 1002 whose output has been set to Pa0 or higher. It is therefore possible to normally eject the ink from the ejection ports 13 in the liquid ejection head 3 and thus perform high-quality printing at high speed on a print medium MD. Thus, based on the result of the evaluation of the ink ejection state by the evaluation unit 151, the setting unit 152 sets the output of the circulation pump 1002 to Pa0 or higher, with which the ink can be normally ejected from the ejection ports 13.

In step S108, the setting unit 152 of the control unit 50 performs a process of setting the output of the circulation pump 1002 to Pal or higher, and the processing ends. Since the result of the determination in the previous step S106 is NO, the ink can be caused to normally circulate through the circulation channel Fw2 by the circulation pump 1002 whose output has been set to Pal or higher. It is therefore possible to normally eject the ink from the ejection ports 13 in the liquid ejection head 3 and thus perform high-quality printing at high speed on a print medium MD. Thus, based on the result of the evaluation of the ink ejection state by the evaluation unit 151, the setting unit 152 sets the output of the circulation pump 1002 to Pa1 or higher, with which the ink can be normally ejected from the ejection ports 13.

In step S109, the evaluation unit 151 of the control unit 50 performs a process of changing the output of the circulation pump 1002 to Pa2 higher than Pa1. In doing so, the evaluation unit 151 controls the pump driver 66 to change the output of the circulation pump 1002 to Pa2. As a result, the ink is caused to circulate through the circulation channel Fw2 by the circulation pump 1002 whose output has been changed from Pa1 to Pa2.

In step S110, as in step S102, the control unit 50 performs a process of printing the evaluation pattern PTN on a print medium MD. Also, at this time, the scanner 63 reads the evaluation pattern PTN on the print medium MD printed by the liquid ejection head 3 and obtains the result of the scan as electronic image data. The scanner 63 sends the obtained image data of the evaluation pattern PTN to the control unit 50.

In step S111, as in step S103, the evaluation unit 151 of the control unit 50 determines whether the evaluation pattern PTN printed on the print medium MD is normal. The processing proceeds to step S112 if the evaluation unit 151 determines that the evaluation pattern PTN printed on the print medium MD is normal, i.e., the result of the determination in step S111 is YES. The processing proceeds to step S113 if the evaluation unit 151 determines that the evaluation pattern PTN printed on the print medium MD is not normal, i.e., the result of the determination in step S111 is NO.

In step S112, the setting unit 152 of the control unit 50 performs a process of setting the output of the circulation pump 1002 to Pa2 or higher, and the processing ends. Since the result of the determination in the previous step S111 is YES, the ink can be caused to normally circulate through the circulation channel Fw2 by the circulation pump 1002 whose output has been set to Pa2 or higher. It is therefore possible to normally eject the ink from the ejection ports 13 in the liquid ejection head 3 and thus perform high-quality printing at high speed on a print medium MD. Thus, based on the result of the evaluation of the ink ejection state by the evaluation unit 151, the setting unit 152 sets the output of the circulation pump 1002 to Pa2 or higher, with which the ink can be normally ejected from the ejection ports 13.

In step S113, the evaluation unit 151 of the control unit 50 performs a process of changing the output of the circulation pump 1002 to Pa3 higher than Pa2. In doing so, the evaluation unit 151 controls the pump driver 66 to change the output of the circulation pump 1002 to Pa3. As a result, the ink is caused to circulate through the circulation channel Fw2 by the circulation pump 1002 whose output has been changed from Pa2 to Pa3.

In step S114, as in step S102, the control unit 50 performs a process of printing the evaluation pattern PTN on a print medium MD. Also, at this time, the scanner 63 reads the evaluation pattern PTN on the print medium MD printed by the liquid ejection head 3 and obtains the result of the scan as electronic image data. The scanner 63 sends the obtained image data of the evaluation pattern PTN to the control unit 50.

In step S115, as in step S103, the evaluation unit 151 of the control unit 50 determines whether the evaluation pattern PTN printed on the print medium MD is normal. The processing proceeds to step S116 if the evaluation unit 151 determines that the evaluation pattern PTN printed on the print medium MD is normal, i.e., the result of the determination in step S115 is YES. If the evaluation unit 151 determines that the evaluation pattern PTN printed on the print medium MD is not normal, i.e., the result of the determination in step S115 is NO, an abnormality notification is made, and the processing ends.

Note that the abnormality notification may be made by a process of displaying information indicating that an abnormality has occurred on a display device or the like (not illustrated). The abnormality notification may be made by a process of displaying information prompting replacement of the liquid ejection head 3 on a display device or the like.

In step S116, the setting unit 152 of the control unit 50 performs a process of setting the output of the circulation pump 1002 to Pa3 or higher, and the processing ends. Since the result of the determination in the previous step S115 is YES, the ink can be caused to normally circulate through the circulation channel Fw2 by the circulation pump 1002 whose output has been set to Pa3 or higher. It is therefore possible to normally eject the ink from the ejection ports 13 in the liquid ejection head 3 and thus perform high-quality printing at high speed on a print medium MD. Thus, based on the result of the evaluation of the ink ejection state by the evaluation unit 151, the setting unit 152 sets the output of the circulation pump 1002 to Pa3 or higher, with which the ink can be normally ejected from the ejection ports 13.

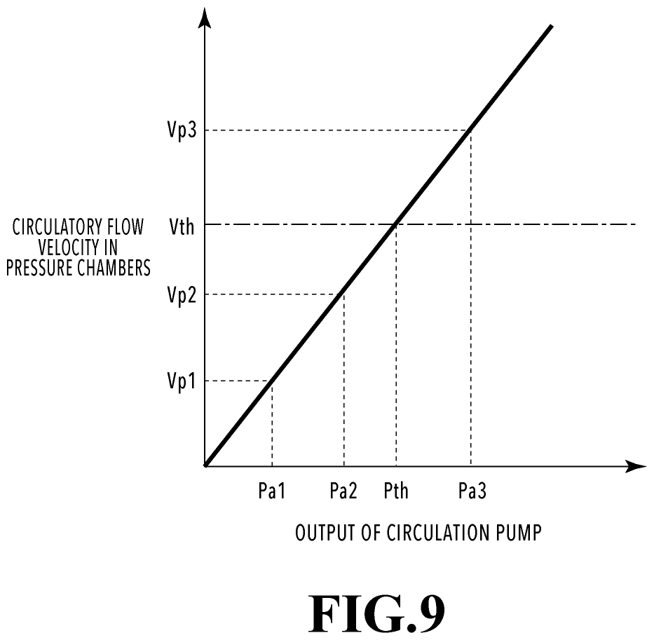

FIG. 9 is a graph illustrating a relationship between the output of the circulation pump 1002 and the circulatory flow velocity of the ink inside the pressure chambers 23. Note that the circulatory flow velocity of the ink refers to the flow velocity of the ink circulating through the circulation channel Fw2. Also, the graph of FIG. 9 indicates a case where the evaluation pattern PTN is determined as not normal if the output of the circulation pump 1002 is Pa1 or Pa2, and the evaluation pattern PTN is determined as normal if the output of the circulation pump 1002 is Pa3. As illustrated in FIG. 9, the circulatory flow velocity of the ink inside the pressure chambers 23 is Vp1 in a case where the output of the circulation pump 1002 is Pa1. The circulatory flow velocity of the ink inside the pressure chambers 23 is Vp2 in a case where the output of the circulation pump 1002 is Pa2. The circulatory flow velocity of the ink inside the pressure chambers 23 is Vp3 in a case where the output of the circulation pump 1002 is Pa3.

In the graph of FIG. 9, a minimum ink circulatory flow velocity Vth with which the evaluation pattern PTN can be normally printed, in other words, the ink can be normally ejected from the ejection ports 13, is considered to exist between Vp2 and Vp3. As long as the minimum ink circulatory flow velocity Vth, with which the ink can be normally ejected from the ejection ports 13, can be detected, high-quality printing can be performed at high speed on a print medium MD by setting the output of the circulation pump 1002 so as to set the circulatory flow velocity of the ink to Vth or higher. According to the present embodiment, by setting the output of the circulation pump 1002 to or above a minimum output Pth which corresponds to Vth and with which the ink can be normally ejected from the ejection ports 13, the circulatory flow velocity of the ink will be higher than Vth, thus enabling proper ink circulation.

As described above, the inkjet printing apparatus 1 (liquid ejection apparatus) and the adjustment method for the inkjet printing apparatus 1 according to the first embodiment can perform proper ink (liquid) circulation while also allowing downsizing of the liquid ejection head 3. Specifically, in the present embodiment, the output of the circulation pump 1002 is changed, the ink ejection state is evaluated, and the output of the circulation pump 1002 is set based on the result of the evaluation of the ink ejection state. For example, in the step of evaluating the ink ejection state, whether the ink ejection state is such that the ink is normally ejected from the ejection ports 13 in the liquid ejection head 3 is evaluated. In a case where the ink ejection state is not such that the ink is normally ejected from the ejection ports 13, the output of the circulation pump 1002 is changed to a higher output, and then whether the ink ejection state is such that the ink is normally ejected from the ejection ports 13 is evaluated again. In a case where the ink ejection state is such that the ink is normally ejected from the ejection ports 13, the output of the circulation pump 1002 may be changed to a lower output, and then whether the ink ejection state is such that the ink is normally ejected from the ejection ports 13 may be evaluated again. By changing the output of the circulation pump 1002 and evaluating the ink ejection state, the output of the circulation pump 1002 can be appropriately set without a pressure sensor or the like provided on the circulation channel Fw2 for the ink flowing through the liquid ejection head 3. Here, proper ink circulation can be done by setting the output of the circulation pump 1002 to an output with which the ink can be normally output from the ejection ports 13 (e.g., an output greater than or equal to Pth). In this way, it is possible to perform proper ink circulation while also allowing downsizing of the liquid ejection head 3.

Also, by determining whether the evaluation pattern PTN is normal based on the evaluation pattern PTN read by the scanner 63, it is possible to evaluate whether the ink ejection state is such that the ink is normally ejected from the ejection ports 13 in the liquid ejection head 3. This enables the ink ejection state is evaluated more simply and easily.

In the above first embodiment, the output of the circulation pump 1002 is changed up to a maximum of Pa3, but the first embodiment is not limited to this. For example, the output of the circulation pump 1002 may be changed to Pa4 that is higher than Pa3 or even to Pa5 that is higher than Pa4.

In the above first embodiment, the evaluation unit 151 of the control unit 50 determines whether the evaluation pattern PTN printed on a print medium MD is normal by image processing. However, the first embodiment is not limited to this. For example, the user may visually determine whether the evaluation pattern PTN printed on a print medium MD is normal. In this case, the operation panel 62 may send input data corresponding to an operation of inputting the result of the determination of whether the evaluation pattern PTN is normal to the control unit 50. Based on the input data on the determination result sent from the operation panel 62, the evaluation unit 151 can evaluate whether the ink ejection state is such that the ink is normally ejected from the ejection ports 13 in the liquid ejection head 3.

### Modification

As mentioned earlier, the present embodiment is not limited to serial-type printing apparatuses but is applicable also to line-type printing apparatuses. Thus, a modification of the first embodiment will now be described. In the modification of the first embodiment, members with similar configurations to those in the above first embodiment are denoted by the same reference signs as those in the first embodiment.

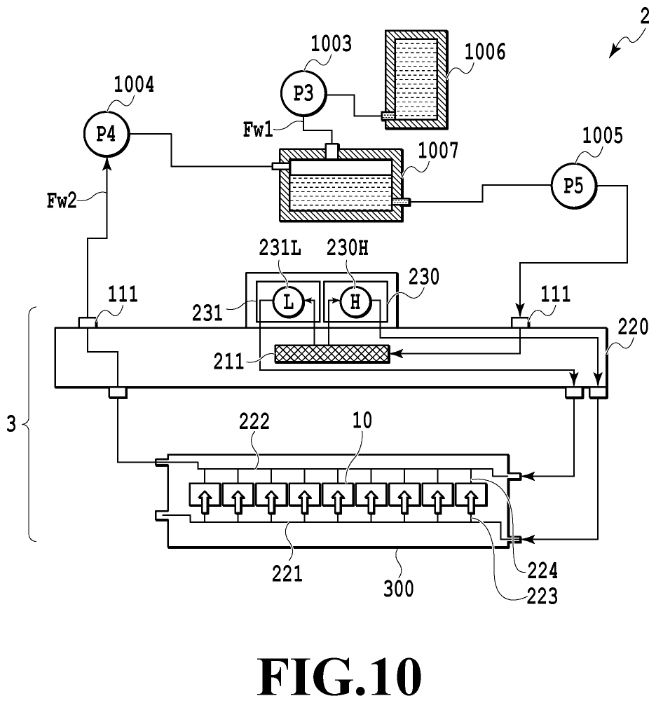

FIG. 10 is a schematic view illustrating an inkjet printing apparatus 2 equipped with line-type heads. As illustrated in FIG. 10, the inkjet printing apparatus 2 according to the modification includes a main tank 1006, a buffer tank 1007, a liquid ejection head 3, a replenishing pump 1003 (P3), a first circulation pump 1004 (P4), and a second circulation pump 1005 (P5). The main tank 1006 is connected to the buffer tank 1007 through the replenishing pump 1003. The main tank 1006 has an atmosphere communication opening (not illustrated) through which the inside and outside of the main tank 1006 communicate with each other, and is capable of discharging air bubbles in the ink to the outside.

The replenishing pump 1003 sends the ink stored in the main tank 1006 to the buffer tank 1007. In a case where the ink is consumed as a result of ejecting the ink from the ejection ports 13 in the liquid ejection head 3 (not illustrated in FIG. 10) for printing on a print medium, suction recovery, or the like, the replenishing pump 1003 sends the consumed amount of the ink to the buffer tank 1007 from the main tank 1006. In the modification, a supply channel Fw1 is formed which is connected to the main tank 1006, the buffer tank 1007, and the liquid ejection head 3 and through which the ink to be supplied to the ejection ports 13 in the liquid ejection head 3 flows. In the modification, a circulation channel Fw2 is formed through which the ink is caused to circulate by the first circulation pump 1004 and the second circulation pump 1005.

The liquid ejection head 3 has a filter 211, a first negative pressure control unit 230 on a higher pressure side, a second negative pressure control unit 231 on a lower pressure side, a liquid supply unit 220, and a liquid ejection unit 300. The filter 211 is disposed between a liquid connection part 111 on an upstream side of the liquid supply unit 220 and the first and second negative pressure control units 230 and 231. The first negative pressure control unit 230 has a first pressure control chamber 230H and a pressure adjustment mechanism (not illustrated) on the higher pressure side. An upstream portion of the first pressure control chamber 230H is connected to the upstream liquid connection part 111 through the filter 211. A downstream portion of the first pressure control chamber 230H is connected to a common supply channel 221 formed in the liquid ejection unit 300 through the liquid supply unit 220. The first negative pressure control unit 230 controls the pressure on the ink flowing through the first pressure control chamber 230H to a pressure lower than the pressure on the ink flowing upstream of the first pressure control chamber 230H with the pressure adjustment mechanism.

The second negative pressure control unit 231 has a second pressure control chamber 231L and a pressure adjustment mechanism (not illustrated) on the lower pressure side. An upstream portion of the second pressure control chamber 231L is connected to the upstream liquid connection part 111 through the filter 211. A downstream portion of the second pressure control chamber 231L is connected to a common collection channel 222 formed in the liquid ejection unit 300 through the liquid supply unit 220. The second negative pressure control unit 231 controls the pressure on the ink flowing through the second pressure control chamber 231L to a pressure lower than the pressure on the ink flowing through the first pressure control chamber 230H with the pressure adjustment mechanism.

The first negative pressure control unit 230 and the second negative pressure control unit 231 have a function of maintaining the pressure inside channels in the liquid ejection unit 300 at a constant set pressure even in a case where the circulatory flow velocity of the ink varies due to a difference in what is called the printing ratio (duty). The pressure adjustment mechanisms of the first negative pressure control unit 230 and the second negative pressure control unit 231 are each constructed using a mechanism similar to what is called a pressure-reducing regulator, for example. In this way, the pressure adjustment mechanisms are capable of controlling the pressure inside the channels in the liquid ejection unit 300 within a certain range of variation centered at the set pressure. In the case where the pressure adjustment mechanisms are each constructed using a mechanism similar to a pressure-reducing regulator, it is desirable to pressurize the upstream sides of the first negative pressure control unit 230 and the second negative pressure control unit 231 with the second circulation pump 1005 via the liquid supply unit 220. This suppresses the effect of the hydraulic head pressure on the liquid ejection head 3 from the buffer tank 1007, and therefore provides more freedom in the layout of the buffer tank 1007.

The liquid ejection unit 300 has multiple printing element substrates 10, the common supply channel 221, the common collection channel 222, and multiple individual supply channels 223 and individual collection channels 224 connected to the multiple printing element substrates 10. The multiple printing element substrates 10 are disposed side by side in the width direction of the print medium, for example. The common supply channel 221 is connected to the first pressure control chamber 230H and the multiple individual supply channels 223. The common collection channel 222 is connected to the second pressure control chamber 231L and the multiple individual collection channels 224. Further, the common supply channel 221 and the common collection channel 222 are connected to the first circulation pump 1004 through the liquid supply unit 220 and a downstream liquid connection part 111. A pressure difference is generated between the ink flowing through the common supply channel 221 and the ink flowing through the common collection channel 222 according to the pressure difference between the first negative pressure control unit 230 and the second negative pressure control unit 231. As a result, as indicated by the bold arrows in FIG. 10, the ink flows such that part of the ink flowing through the common supply channel 221 passes through the channels inside the printing element substrates 10 and heads toward the common collection channel 222.

In the liquid ejection unit 300, the ink flows so as to pass through the common supply channel 221 and the common collection channel 222, and part of the ink flowing through the common supply channel 221 passes through the channels inside the printing element substrates 10 and heads toward the common supply channel 222. In this way, heat generated in the printing element substrates 10 is discharged to the outside of the liquid ejection head 3 (liquid ejection unit 300) by means of the ink flowing through the common supply channel 221 and the common collection channel 222. Note that the supply channel Fw1 includes the upstream liquid connection part 111, the filter 211, the first pressure control chamber 230H, the common supply channel 221, and the multiple individual supply channels 223. The circulation channel Fw2 includes the upstream and downstream liquid connection parts 111, the filter 211, the first pressure control chamber 230H, the second pressure control chamber 231L, the common supply channel 221, the common collection channel 222, and the multiple individual supply channels 223, and individual collection channels 224.

The first circulation pump 1004 draws out the ink through the downstream liquid connection part 111 of the liquid ejection head 3 and sends it to the buffer tank 1007. A positive displacement pump having the ability to send a constant amount of liquid is desirably used as the first circulation pump 1004. For example, a tube pump, a gear pump, a diaphragm pump, a syringe pump, or the like may be used as the positive displacement pump. The first circulation pump 1004 may include a general constant flow valve or a relief valve disposed at the exit of the first circulation pump 1004 to ensure a constant flow rate. While the liquid ejection head 3 is in operation, the ink is caused to flow through the common supply channel 221 and the common collection channel 222 in the liquid ejection unit 300 at a constant flow rate by the first circulation pump 1004. The flow rate of the ink flowing through the common supply channel 221 and the common collection channel 222 is preferably set to or above such a flow rate that the temperature difference between the multiple printing element substrates 10 does not affect the print image quality. Also, in a case where the flow rate of the ink flowing through the common supply channel 221 and the common collection channel 222 is set to an excessively high flow rate, the negative pressure difference between the multiple printing element substrates 10 will be excessively large due to the effect of the pressure loss at the channels in the liquid ejection unit 300. This will result in uneven density in the image printed on the print medium. It is therefore desirable to set the flow rate of the ink flowing through the common supply channel 221 and the common collection channel 222 with the temperature difference and negative pressure difference between the multiple printing element substrates 10 taken into account.

The second circulation pump 1005 sends the ink stored in the buffer tank 1007 to the first negative pressure control unit 230 and the second negative pressure control unit 231 through the upstream liquid connection part 111 and the filter 211. The second circulation pump 1005 may be any pump as long as its output can generate an ink flow while the liquid ejection head 3 is in operation. The second circulation pump 1005 is constructed using a turbo pump, a positive displacement pump, or the like. For example, a diaphragm pump or the like is used as the positive displacement pump. Also, instead of the second circulation pump 1005, a tank may be provided which is disposed with a certain hydraulic head difference set with respect to the first negative pressure control unit 230, for example.

The ink stored in the buffer tank 1007 is caused to flow into the liquid ejection head 3 through the upstream liquid connection part 111 by the second circulation pump 1005. Part of the ink having passed the upstream liquid connection part 111 flows through the filter 211 and the first negative pressure control unit 230 (first pressure control chamber 230H) into the common supply channel 221 in the liquid ejection unit 300. The other part of the ink having passed the upstream liquid connection part 111 flows through the filter 211 and the second negative pressure control unit 231 (second pressure control chamber 231L) into the common collection channel 222 in the liquid ejection unit 300. Part of the ink flowing through the common supply channel 221 is supplied to the printing element substrates 10 having the ejection ports 13. Part of the ink supplied to the ejection ports 13 in the printing element substrate 10 is ejected from the ejection ports 13. The ink that has not been ejected from the ejection ports 13 is caused to flow into the common collection channel 222 by the pressure difference between the common supply channel 221 and the common collection channel 222. The ink flowing through the common supply channel 221 and the ink flowing through the common collection channel 222 are returned to the buffer tank 1007 by the first circulation pump 1004 through the downstream liquid connection part 111.

In the modification, the outputs of the first circulation pump 1004 and the second circulation pump 1005 are changed, the ink ejection state is then evaluated, and the outputs of the first circulation pump 1004 and the second circulation pump 1005 are set based on the result of the evaluation of the ink ejection state. For example, in a case where the ink ejection state is not such that the ink is normally ejected from the ejection ports 13, the outputs of the circulation pumps 1004 and 1005 are changed to higher outputs, and then whether the ink ejection state is such that the ink is normally ejected from the ejection ports 13 is evaluated again. In a case where the ink ejection state is such that the ink is normally ejected from the ejection ports 13, the outputs of the circulation pumps 1004 and 1005 may be changed to lower outputs, and then whether the ink ejection state is such that the ink is normally ejected from the ejection ports 13 may be evaluated again. Thus, by performing similar processes to those in the first embodiment, the outputs of the first circulation pump 1004 and the second circulation pump 1005 can be appropriately set without a pressure sensor or the like provided on the circulation channel Fw2 for the ink flowing through the liquid ejection head 3. Hence, it is possible to perform proper ink circulation while also allowing downsizing of the liquid ejection head 3.

### Second Embodiment

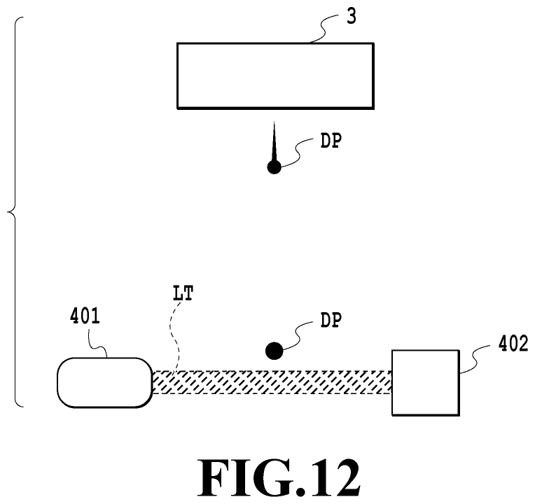

Next, a second embodiment will be described. Each individual member in the second embodiment has a similar configuration to that in the above first embodiment. Thus, the description will be given with the same reference signs given to these members as those in the above first embodiment. The inkjet printing apparatus 1 according to the second embodiment is provided with a light source 401 and an optical sensor 402 (see FIG. 12) in place of the scanner 63.

### Adjustment Method for Inkjet Printing Apparatus

An adjustment method for the inkjet printing apparatus 1 according to the second embodiment will be described as an adjustment method for a liquid ejection apparatus. As in the first embodiment, the control unit 50 performs control for transitioning to a pump adjustment mode in a case where printing is performed on a certain number of print media MD or a certain time period elapses. Note that, as in the first embodiment, the control unit 50 may be configured to perform the control for transitioning to the pump adjustment mode in response to an operation on the operation panel 62 by the user.

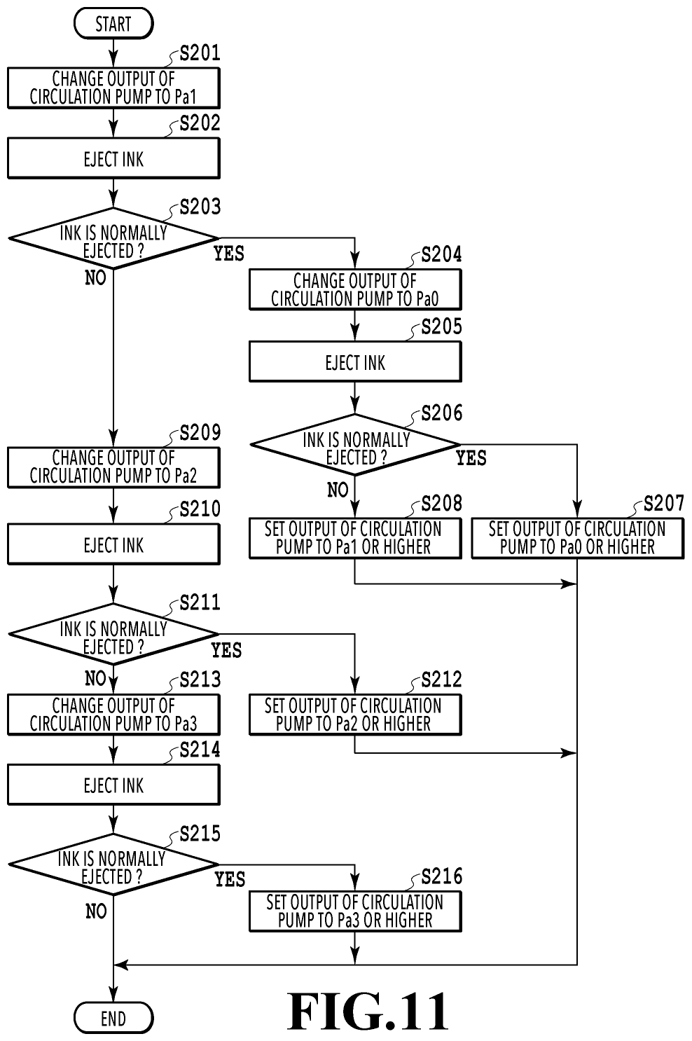

FIG. 11 is a flowchart illustrating steps in the pump adjustment mode according to the second embodiment. Note that the steps (processes) in the flowchart illustrated in FIG. 11 are executed by the CPU 51 executing a control program stored in the ROM 53 of the control unit 50.

First, as in the first embodiment, in step S201, the evaluation unit 151 of the control unit 50 performs a process of changing the output of the circulation pump 1002 to any value Pa1.

In step S202, the control unit 50 performs a process of ejecting the ink from the ejection ports 13 by actuating the heaters 15 (ejection elements) in the liquid ejection head 3. In doing so, the CPU 51, for example, controls the head driver 65 based on adjustment data stored in the ROM 53 to control the actuation of the heaters 15 provided in the liquid ejection head 3. As a result, the liquid ejection head 3 ejects the ink from the ejection ports 13 by the actuation of the heaters 15. Note that the second embodiment does not involve printing the evaluation pattern PTN on a print medium MD. Also, at this time, the optical sensor 402 (see FIG. 12) detects droplets DP (see FIG. 12) ejected from the ejection ports 13.

FIG. 12 is a schematic view the light source 401 and the optical sensor 402. The light source 401 and the optical sensor 402 are disposed at positions separated from the liquid ejection head 3 in the direction in which the ink is ejected. The optical sensor 402 receives light LT emitted from the light source 401. When a droplet DP ejected from an ejection port 13 passes between the light source 401 and the optical sensor 402, the droplet DP blocks the light LT being received by the optical sensor 402. The optical sensor 402 is capable of detecting the droplet DP ejected from the ejection port 13 by detecting the blockage of the light by the droplet DP. For example, the light source 401 and the optical sensor 402 can be used to detect the time for which the light is blocked by the droplet DP. It is also possible to detect the velocity of droplets DP ejected from the ejection ports 13, the volume of the droplets DP, and the like by using multiple light sources 401 and optical sensors 402. In this way, it is possible to accurately determine whether the ink is normally ejected from the ejection ports 13. The optical sensor 402 sends a detection signal corresponding to the result of the detection of droplets DP to the control unit 50.

Referring back to FIG. 11, in step S203, the evaluation unit 151 of the control unit 50 determines whether the ink is normally ejected from the ejection ports 13 based on the detection signal sent from the optical sensor 402. In other words, the evaluation unit 151 evaluates whether the ink ejection state is such that the ink is normally ejected from the ejection ports 13 based on the detection signal sent from the optical sensor 402.

The processing proceeds to step S204 if the evaluation unit 151 determines that the ink is normally ejected from the ejection ports 13, i.e., the result of the determination in step S203 is YES. The processing proceeds to step S209 if the evaluation unit 151 determines that the ink is not normally ejected from the ejection ports 13, i.e., the result of the determination in step S203 is NO.

In step S204, as in the first embodiment, the evaluation unit 151 of the control unit 50 performs a process of changing the output of the circulation pump 1002 to Pa0 lower than Pa1.

In step S205, as in step S202, the control unit 50 performs a process of ejecting the ink from the ejection ports 13 by actuating the heaters 15 in the liquid ejection head 3. Also, at this time, the optical sensor 402 detects the droplets DP ejected from the ejection ports 13. The optical sensor 402 sends a detection signal corresponding to the result of the detection of the droplets DP to the control unit 50.

In step S206, as in step S203, the evaluation unit 151 of the control unit 50 determines whether the ink is normally ejected from the ejection ports 13 based on the detection signal sent from the optical sensor 402. The processing proceeds to step S207 if the evaluation unit 151 determines that the ink is normally ejected from the ejection ports 13, i.e., the result of the determination in step S206 is YES. The processing proceeds to step S208 if the evaluation unit 151 determines that the ink is not normally ejected from the ejection ports 13, i.e., the result of the determination in step S206 is NO.

In step S207, the setting unit 152 of the control unit 50 performs a process of setting the output of the circulation pump 1002 to Pa0 or higher, and the processing ends. As in the first embodiment, based on the result of the evaluation of the ink ejection state by the evaluation unit 151, the setting unit 152 sets the output of the circulation pump 1002 to Pa0 or higher, with which the ink can be normally ejected from the ejection ports 13.

In step S208, the setting unit 152 of the control unit 50 performs a process of setting the output of the circulation pump 1002 to Pa1 or higher, and the processing ends. As in the first embodiment, based on the result of the evaluation of the ink ejection state by the evaluation unit 151, the setting unit 152 sets the output of the circulation pump 1002 to Pa1 or higher, with which the ink can be normally ejected from the ejection ports 13.

In step S209, as in the first embodiment, the evaluation unit 151 of the control unit 50 performs a process of changing the output of the circulation pump 1002 to Pa2 higher than Pa1.

In step S210, as in step S202, the control unit 50 performs a process of ejecting the ink from the ejection ports 13 by actuating the heaters 15 in the liquid ejection head 3. Also, at this time, the optical sensor 402 detects the droplets DP ejected from the ejection ports 13. The optical sensor 402 sends a detection signal corresponding to the result of the detection of the droplets DP to the control unit 50.

In step S211, as in step S203, the evaluation unit 151 of the control unit 50 determines whether the ink is normally ejected from the ejection ports 13 based on the detection signal sent from the optical sensor 402. The processing proceeds to step S212 if the evaluation unit 151 determines that the ink is normally ejected from the ejection ports 13, i.e., the result of the determination in step S211 is YES. The processing proceeds to step S213 if the evaluation unit 151 determines that the ink is not normally ejected from the ejection ports 13, i.e., the result of the determination in step S211 is NO.

In step S212, the setting unit 152 of the control unit 50 performs a process of setting the output of the circulation pump 1002 to Pa2 or higher, and the processing ends. As in the first embodiment, based on the result of the evaluation of the ink ejection state by the evaluation unit 151, the setting unit 152 sets the output of the circulation pump 1002 to Pa2 or higher, with which the ink can be normally ejected from the ejection ports 13.

In step S213, as in the first embodiment, the evaluation unit 151 of the control unit 50 performs a process of changing the output of the circulation pump 1002 to Pa3 higher than Pa2.

In step S214, as in step S202, the control unit 50 performs a process of ejecting the ink from the ejection ports 13 by actuating the heaters 15 in the liquid ejection head 3. Also, at this time, the optical sensor 402 detects the droplets DP ejected from the ejection ports 13. The optical sensor 402 sends a detection signal corresponding to the result of the detection of the droplets DP to the control unit 50.

In step S215, as in step S203, the evaluation unit 151 of the control unit 50 determines whether the ink is normally ejected from the ejection ports 13 based on the detection signal sent from the optical sensor 402. The processing proceeds to step S216 if the evaluation unit 151 determines that the ink is normally ejected from the ejection ports 13, i.e., the result of the determination in step S215 is YES. If the evaluation unit 151 determines that the ink is not normally ejected from the ejection ports 13, i.e., the result of the determination in step S215 is NO, an abnormality notification is made, and the processing ends.

Note that the abnormality notification may be made by a process of displaying information indicating that an abnormality has occurred on a display device or the like (not illustrated). The abnormality notification may be made by a process of displaying information prompting replacement of the liquid ejection head 3 on a display device or the like.

In step S216, the setting unit 152 of the control unit 50 performs a process of setting the output of the circulation pump 1002 to Pa3 or higher, and the processing ends. As in the first embodiment, based on the result of the evaluation of the ink ejection state by the evaluation unit 151, the setting unit 152 sets the output of the circulation pump 1002 to Pa3 or higher, with which the ink can be normally ejected from the ejection ports 13.

As described above, according to the second embodiment, it is possible to perform proper ink (liquid) circulation while also allowing downsizing of the liquid ejection head 3, as in the first embodiment.

Also, the evaluation unit 151 evaluates whether the ink ejection state is such that the ink is normally ejected from the ejection ports 13 based on the detection signal sent from the optical sensor 402. In this way, no print medium is required, so that the ink ejection state is evaluated more simply and easily. In the evaluation of the ink ejection state, the liquid ejection head 3 may eject the ink into a cap (not illustrated) that covers the tip of the liquid ejection head 3 to prevent drying of the ink from the ejection ports 13, since printing on a print medium is not required.

Note that the present embodiment is not limited to serial-type printing apparatuses but is applicable also to line-type printing apparatuses, like the first embodiment.

In the above second embodiment, the output of the circulation pump 1002 is changed up to a maximum of Pa3, but the second embodiment is not limited to this. For example, the output of the circulation pump 1002 may be changed to Pa4 that is higher than Pa3 or even to Pa5 that is higher than Pa4.

### Modification

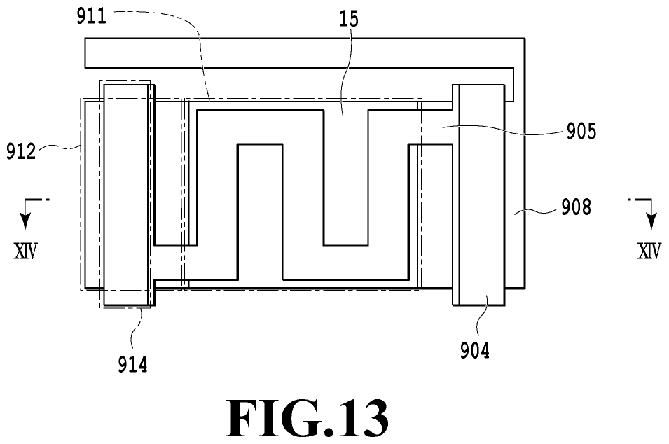

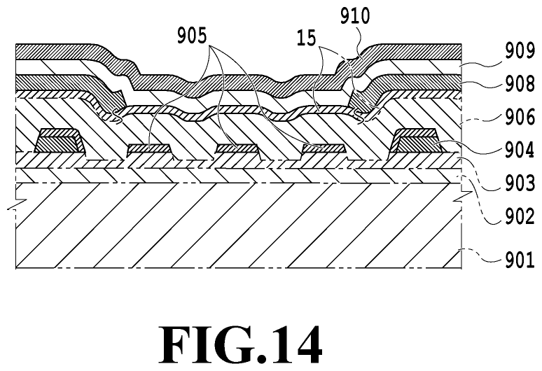

In the above second embodiment, the evaluation unit 151 evaluates whether the ink ejection state is such that the ink is normally ejected from the ejection ports 13 based on the detection signal sent from the optical sensor 402, but the second embodiment is not limited to this. For example, the evaluation unit 151 may evaluate whether the ink ejection state is such that the ink is normally ejected from the ejection ports 13 based on detection signals sent from temperature detection elements 905 (see FIGS. 13 and 14). Thus, a modification of the second embodiment will now be described. In the modification of the second embodiment, members with similar configurations to those in the above first embodiment are denoted by the same reference signs as those in the first embodiment. The inkjet printing apparatus 1 according to the modification of the second embodiment is provided with the temperature detection elements 905 in place of the light source 401 and the optical sensor 402.

FIG. 13 is a plan view illustrating a positional relationship between a temperature detection element 905 and a heater 15. FIG. 14 is a cross-sectional view taken along the line XIV-XIV in FIG. 13. As illustrated in FIGS. 13 and 14, each temperature detection element 905 is provided near a corresponding heater 15 in the printing element substrate 10. Note that illustration of some of the films forming the printing element substrate 10 is omitted in FIG. 13. FIG. 13 is a transparent view illustrating a positional relationship between a temperature detection element 905 and a heater 15 as seen from a silicon substrate 901 side.

In the printing element substrate 10 according to the modification, multiple films are formed on the silicon substrate 901 forming the substrate 11 described earlier, as illustrated in FIG. 14. Specifically, a field oxide film 902 and an insulating film 903 (phosphosilicate glass (PSG) film) are formed in this order on the silicon substrate 901. The field oxide film 902 is formed using silicon dioxide (SiO2) or the like. The temperature detection elements 905 and first wirings 904 made of aluminum are formed on the insulating film 903. The temperature detection elements 905 are formed using temperature-measuring resistors made of aluminum (Al), platinum (Pt), titanium (Ti), tantalum (Ta), or the like. The first wirings 904 are electrically connected to the temperature detection elements 905.

An interlayer insulating film 906 is formed using silicon monoxide (SiO) or the like on the temperature detection element 905 (and on the insulating film 903). The heaters 15 and second wirings 908 made of aluminum are formed on the interlayer insulating film 906. The heaters 15 are formed using TaSiN. The heaters 15 are electrically connected to the second wirings 908 and convert electrical energy into thermal energy. The second wirings 908 are electrically connected to a driving circuit (not illustrated) formed on the silicon substrate 901 and to the heaters 15.

A passivation film 909 is formed using silicon monoxide (SiO) or the like on the heaters 15 (and on the second wirings 908). An anti-cavitation film 910 is formed using tantalum (Ta), iridium (Ir), or the like on the passivation film 909. The anti-cavitation film 910 enhances cavitation resistance on the heaters 15.

The multiple films on the silicon substrate 901 are formed by semiconductor fabrication processes. For example, by performing film formation, patterning, and so on the insulating film 903, the temperature detection elements 905 can be formed without significantly changing a conventional printing element substrate structure.

FIG. 13 illustrates a region 911 of a heater 15, a region 912 of a second wiring 908, and a region 914 of a first wiring 904 as viewed from the silicon substrate 901 side. As illustrated in FIG. 13, each temperature detection element 905 is formed in a shape that meanders in a zigzag manner at a position overlapping the region 911 of the corresponding heater 15. Forming the temperature detection element 905 in the meandering fashion increases the length of the temperature detection element 905 and therefore increases the value of resistance of the temperature detection element 905. The higher the value of resistance of the temperature detection element 905 is, the larger a temperature detection signal will be output from the temperature detection element 905, and hence the more accurately a temperature change will be detected. Note that, in the example illustrated in FIG. 13, the temperature detection element 905 is formed in a shape that meanders in a zigzag manner but is not limited to this. For example, the temperature detection element 905 may be formed in a rectangular shape.

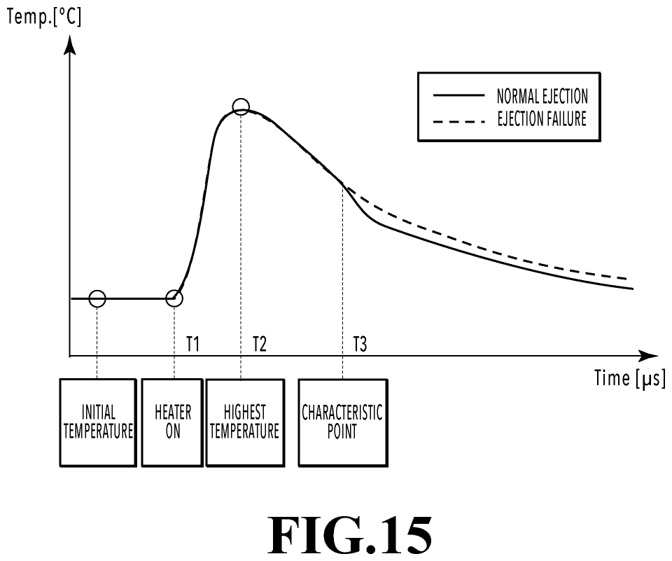

FIG. 15 is a graph illustrating a temperature profile during normal ejection and a temperature profile during ejection failure detected by a temperature detection element 905. Normal ejection refers to a case where the ink is normally ejected from the ejection port 13. Ejection failure refers to a case where the ink is not ejected from the ejection port 13. In the graph illustrated in FIG. 15, the solid line represents the temperature profile during normal ejection, and the dashed line represents the temperature profile during ejection failure. The vertical axis of the graph illustrated in FIG. 15 represents the temperature detected by the temperature detection element 905 (unit: ° C.). The horizontal axis of the graph illustrated in FIG. 15 represents time (unit: μs). Here, a driving voltage is applied to the heater 15 at a time T1 and the temperature detected by the temperature detection element 905 reaches the highest temperature a time T2.

As indicated by the solid line in FIG. 15, the temperature profile during normal ejection indicates, for example, a characteristic point at a time T3 from which the temperature detected by the temperature detection element 905 abruptly drops after the temperature reaches the highest temperature. As indicated by the dashed line in FIG. 15, the temperature profile during ejection failure does not indicate the characteristic point from which the temperature detected by the temperature detection element 905 abruptly drops after the temperature reaches the highest temperature. At the time of ejecting the ink from the ejection port 13 by actuating the heater 15, a bubble generated by film boiling by the heater 15 shrinks after growing to the largest size. As the bubble shrinks, a force that pulls the droplet ejected from the ejection port 13 toward the inside of the pressure chamber 23 is exerted, so that part of the droplet ejected from the ejection port 13 returns onto the heater 15. Since part of the droplet ejected from the ejection port 13 and therefore cooled returns onto the heater 15, the characteristic point from which the temperature abruptly drops appears. By detecting the present or absence of this characteristic point with the temperature detection element 905, it is possible to evaluate whether the ink ejection state is such that the ink is normally ejected from the ejection port 13.

Thus, by performing processes similar to those in the second embodiment, it is possible to perform proper ink (liquid) circulation while also allowing downsizing of the liquid ejection head 3, as in the first embodiment.

Also, the evaluation unit 151 evaluates whether the ink ejection state is such that the ink is normally ejected from the ejection ports 13 based on the detection signals sent from the temperature detection elements 905. In this way, no print medium is required, so that the ink ejection state is evaluated more simply and easily. In the evaluation of the ink ejection state, the liquid ejection head 3 may eject the ink into a cap (not illustrated) that covers the tip of the liquid ejection head 3 to prevent drying of the ink from the ejection ports 13, since printing on a print medium is not required. Also, according to the modification, the inkjet printing apparatus 1 does not need to be provided with a separate sensor unit. This allows downsizing of the inkjet printing apparatus 1.

### Third Embodiment

Next, a third embodiment will be described. Each individual member in the third embodiment has a similar configuration to that in the above first embodiment. Thus, the description will be given with the same reference signs given to these members as those in the above first embodiment. The inkjet printing apparatus 1 according to the third embodiment is provided with a light source 401 and an optical sensor 402 similar to those in the second embodiment in place of the scanner 63.

### Adjustment Method for Inkjet Printing Apparatus

An adjustment method for the inkjet printing apparatus 1 according to the third embodiment will be described as an adjustment method for a liquid ejection apparatus. As in the first embodiment, the control unit 50 performs control for transitioning to a pump adjustment mode in a case where printing is performed on a certain number of print media MD or a certain time period elapses. Note that, as in the first embodiment, the control unit 50 may be configured to perform the control for transitioning to the pump adjustment mode in response to an operation on the operation panel 62 by the user.

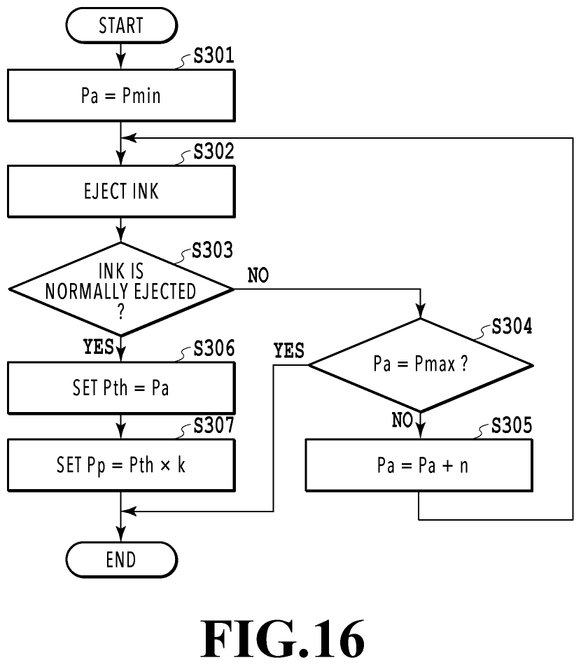

FIG. 16 is a flowchart illustrating steps in the pump adjustment mode according to the third embodiment. The third embodiment employs a procedure involving detecting the minimum ink circulatory flow velocity Vth, with which the ink can be normally ejected from the ejection ports 13, and setting an output Pp of the circulation pump 1002 such that the circulatory flow velocity of the ink will be higher than Vth. Note that the steps (processes) in the flowchart illustrated in FIG. 16 are executed by the CPU 51 executing a control program stored in the ROM 53 of the control unit 50.

First, in step S301, the evaluation unit 151 of the control unit 50 performs a process of changing an output Pa of the circulation pump 1002 to a minimum output Pmin that is settable for the circulation pump 1002. In doing so, the evaluation unit 151 controls the pump driver 66 to change the output Pa of the circulation pump 1002 to Pmin. As a result, the ink is caused to circulate through the circulation channel Fw2 by the circulation pump 1002 whose output has been set to Pa=Pmin.

In step S302, as in the second embodiment, the control unit 50 performs a process of ejecting the ink from the ejection ports 13 by actuating the heaters 15 (ejection elements) in the liquid ejection head 3. Also, at this time, the optical sensor 402 detects the droplets DP ejected from the ejection ports 13. The optical sensor 402 sends a detection signal corresponding to the result of the detection of the droplets DP to the control unit 50.

In step S303, as in the second embodiment, the evaluation unit 151 of the control unit 50 determines whether the ink is normally ejected from the ejection ports 13 based on the detection signal sent from the optical sensor 402. The processing proceeds to step S304 if the evaluation unit 151 determines that the ink is not normally ejected from the ejection ports 13, i.e., the result of the determination in step S303 is NO. The processing proceeds to step S306 if the evaluation unit 151 determines that the ink is normally ejected from the ejection ports 13, i.e., the result of the determination in step S303 is YES.

In step S304, the evaluation unit 151 of the control unit 50 determines whether the output Pa of the circulation pump 1002 is a maximum output Pmax that is settable for the circulation pump 1002. In other words, the evaluation unit 151 determines whether the output Pa of the circulation pump 1002=Pmax. The processing proceeds to step S305 if the evaluation unit 151 determines that the output Pa of the circulation pump 1002≠Pmax, i.e., the result of the determination in step S304 is NO. If the evaluation unit 151 determines that the output Pa of the circulation pump 1002=Pmax, i.e., the result of the determination in step S304 is YES, an abnormality notification is made, and the processing ends.

Note that the abnormality notification may be made by a process of displaying information indicating that an abnormality has occurred on a display device or the like (not illustrated). The abnormality notification may be made by a process of displaying information prompting replacement of the liquid ejection head 3 on a display device or the like.

In step S305, the evaluation unit 151 of the control unit 50 performs a process of increasing the output Pa of the circulation pump 1002 by a fixed value n. In doing so, the evaluation unit 151 controls the pump driver 66 to change the output Pa of the circulation pump 1002 to Pa+n. As a result, the ink is caused to circulate through the circulation channel Fw2 by the circulation pump 1002 whose output has been set to Pa=Pa+n. The evaluation unit 151 returns to step S302 after performing the process of increasing the output Pa of the circulation pump 1002 by the fixed value n.

In step S306, the setting unit 152 of the control unit 50 performs a process of setting the minimum output Pth, with which the ink can be normally ejected from the ejection ports 13, to Pa. Since the result of the determination in the previous step S303 is YES, the ink can be caused to normally circulate through the circulation channel Fw2 by the circulation pump 1002 whose output has been set to Pa. It is therefore possible to normally eject the ink from the ejection ports 13 in the liquid ejection head 3 and thus perform high-quality printing at high speed on a print medium MD.

In step S307, the setting unit 152 of the control unit 50 performs a process of setting the output Pp of the circulation pump 1002 to be actually used to Pth×k, and the processing ends. Note that the coefficient k is a fixed coefficient set within the range of 1.05 to 5, inclusive. The output Pp of the circulation pump 1002 to be actually used is derived by multiplying the minimum output Pth of the circulation pump 1002, with which the ink can be normally ejected from the ejection ports 13, by the fixed coefficient k. This keeps a slight environmental change, variation in the ink ejection state, or the like from preventing the normal ejection of the ink from the ejection ports 13. Also, setting the fixed coefficient within the range of 1.05 to 5, inclusive, will keep the output of the circulation pump 1002 from becoming excessively high and therefore lengthen the life of the circulation pump 1002.

As described above, according to the third embodiment, it is possible to perform proper ink (liquid) circulation while also allowing downsizing of the liquid ejection head 3, as in the first embodiment.

Also, the evaluation unit 151 evaluates whether the ink ejection state is such that the ink is normally ejected from the ejection ports 13 based on the detection signal sent from the optical sensor 402. In this way, no print medium is required, so that the ink ejection state is evaluated more simply and easily. In the evaluation of the ink ejection state, the liquid ejection head 3 may eject the ink into a cap (not illustrated) that covers the tip of the liquid ejection head 3 to prevent drying of the ink from the ejection ports 13, since printing on a print medium is not required.

Note that the present embodiment is not limited to serial-type printing apparatuses but is applicable also to line-type printing apparatuses, like the first embodiment.

In the above third embodiment, the evaluation unit 151 evaluates whether the ink ejection state is such that the ink is normally ejected from the ejection ports 13 based on the detection signal sent from the optical sensor 402, but the third embodiment is not limited to this. For example, as in the modification of the second embodiment, the evaluation unit 151 may evaluate whether the ink ejection state is such that the ink is normally ejected from the ejection ports 13 based on the detection signals sent from the temperature detection elements 905. As in the first embodiment, the evaluation unit 151 may evaluate whether the ink ejection state is such that the ink is normally ejected from the ejection ports 13 in the liquid ejection head 3 based on the evaluation pattern PTN read by the scanner 63. In this case, the evaluation unit 151 may evaluate the ink ejection state after printing all evaluation patterns PTN with the output of the circulation pump 1002 varied. This makes it possible to evaluate the ink ejection state in a short period of time.

In the above third embodiment, the evaluation unit 151 increases the output Pa of the circulation pump 1002 by the fixed value n from the minimum output Pmin settable for the circulation pump 1002, but the third embodiment is not limited to this. For example, the evaluation unit 151 may decrease the output Pa of the circulation pump 1002 by the fixed value n from the maximum output Pmax settable for the circulation pump 1002. In this way, the ink ejection state will be such that the ink will be normally ejected from the ejection ports 13 from the beginning. This will prevent the viscosity of the ink in the ejection ports 13 from rising before detecting the minimum ink circulatory flow velocity Vth (and Pth), with which the ink can be normally ejected from the ejection ports 13. Accordingly, the detected minimum ink circulatory flow velocity Vth and minimum output Pth will be less likely to vary.

### Fourth Embodiment

Next, a fourth embodiment will be described. Each individual member in the fourth embodiment has a similar configuration to that in the above first embodiment. Thus, the description will be given with the same reference signs given to these members as those in the above first embodiment. The inkjet printing apparatus 1 according to the fourth embodiment is provided with a light source 401 and an optical sensor 402 similar to those in the second embodiment in place of the scanner 63.

### Adjustment Method for Inkjet Printing Apparatus

An adjustment method for the inkjet printing apparatus 1 according to the fourth embodiment will be described as an adjustment method for a liquid ejection apparatus. As in the first embodiment, the control unit 50 performs control for transitioning to a pump adjustment mode in a case where printing is performed on a certain number of print media MD or a certain time period elapses. Note that, as in the first embodiment, the control unit 50 may be configured to perform the control for transitioning to the pump adjustment mode in response to an operation on the operation panel 62 by the user.

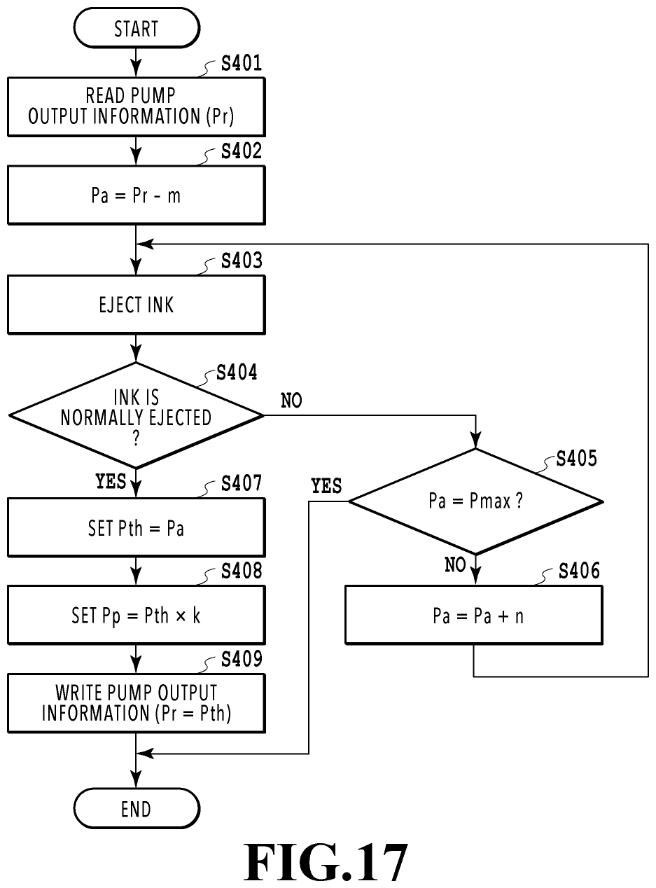

FIG. 17 is a flowchart illustrating steps in the pump adjustment mode according to the fourth embodiment. The fourth embodiment employs a procedure involving setting an output Pp of the circulation pump 1002 based on an output Pr of the circulation pump 1002 stored in a storage element (e.g., a ROM or the like) provided to the liquid ejection head 3. Note that the steps (processes) in the flowchart illustrated in FIG. 17 are executed by the CPU 51 executing a control program stored in the ROM 53 of the control unit 50.

First, in step S401, the evaluation unit 151 of the control unit 50 reads information on the output Pr of the circulation pump 1002 stored in the storage element of the liquid ejection head 3.

In step S402, the evaluation unit 151 of the control unit 50 performs a process of changing an output Pa of the circulation pump 1002 to Pr-m. In doing so, the evaluation unit 151 controls the pump driver 66 to change the output Pa of the circulation pump 1002 to Pr-m. As a result, the ink is caused to circulate through the circulation channel Fw2 by the circulation pump 1002 whose output has been set to Pa =Pr-m.

Note that the output Pr of the circulation pump 1002 stored in the storage element of the liquid ejection head 3 is the minimum output Pth derived in the last adjustment, with which the ink can be normally ejected from the ejection ports 13. In the current adjustment, the output Pa of the circulation pump 1002 is set to an output that is lower by a fixed value m than the output Pr (Pth) of the circulation pump 1002 stored in the storage element because Pth may have been changed since the last adjustment. For example, in a case where the circulation pump 1002 is constructed using a piezoelectric pump, the fixed value m is set to 10 V if the driving voltage for the piezoelectric element corresponding to Pth is 80 V. In this case, the driving voltage for the piezoelectric element corresponding to Pa is 70 V.

In step S403, as in the second embodiment, the control unit 50 performs a process of ejecting the ink from the ejection ports 13 by actuating the heaters 15 (ejection elements) in the liquid ejection head 3. Also, at this time, the optical sensor 402 detects the droplets DP ejected from the ejection ports 13. The optical sensor 402 sends a detection signal corresponding to the result of the detection of the droplets DP to the control unit 50.

In step S404, as in the second embodiment, the evaluation unit 151 of the control unit 50 determines whether the ink is normally ejected from the ejection ports 13 based on the detection signal sent from the optical sensor 402. The processing proceeds to step S405 if the evaluation unit 151 determines that the ink is not normally ejected from the ejection ports 13, i.e., the result of the determination in step S404 is NO. The processing proceeds to step S407 if the evaluation unit 151 determines that the ink is normally ejected from the ejection ports 13, i.e., the result of the determination in step S404 is YES.

In step S405, the evaluation unit 151 of the control unit 50 determines whether the output Pa of the circulation pump 1002 is a maximum output Pmax that is settable for the circulation pump 1002. In other words, the evaluation unit 151 determines whether the output Pa of the circulation pump 1002=Pmax. The processing proceeds to step S406 if the evaluation unit 151 determines that the output Pa of the circulation pump 1002≠Pmax, i.e., the result of the determination in step S405 is NO. If the evaluation unit 151 determines that the output Pa of the circulation pump 1002=Pmax, i.e., the result of the determination in step S405 is YES, an abnormality notification is made, and the processing ends.

Note that the abnormality notification may be made by a process of displaying information indicating that an abnormality has occurred on a display device or the like (not illustrated). The abnormality notification may be made by a process of displaying information prompting replacement of the liquid ejection head 3 on a display device or the like.

In step S406, the evaluation unit 151 of the control unit 50 performs a process of increasing the output Pa of the circulation pump 1002 by a fixed value n. In doing so, the evaluation unit 151 controls the pump driver 66 to change the output Pa of the circulation pump 1002 to Pa+n. As a result, the ink is caused to circulate through the circulation channel Fw2 by the circulation pump 1002 whose output has been set to Pa=Pa+n. The evaluation unit 151 returns to step S403 after performing the process of increasing the output Pa of the circulation pump 1002 by the fixed value n.

In step S407, the setting unit 152 of the control unit 50 performs a process of setting the minimum output Pth, with which the ink can be normally ejected from the ejection ports 13, to Pa. Since the result of the determination in the previous step S404 is YES, the ink can be caused to normally circulate through the circulation channel Fw2 by the circulation pump 1002 whose output has been set to Pa. It is therefore possible to normally eject the ink from the ejection ports 13 in the liquid ejection head 3 and thus perform high-quality printing at high speed on a print medium MD.

In step S408, the setting unit 152 of the control unit 50 performs a process of setting the output Pp of the circulation pump 1002 to be actually used to Pth×k. Note that the coefficient k is a fixed coefficient set within the range of 1.05 to 5, inclusive. The output Pp of the circulation pump 1002 to be actually used is derived by multiplying the minimum output Pth of the circulation pump 1002, with which the ink can be normally ejected from the ejection ports 13, by the fixed coefficient k. This keeps a slight environmental change, variation in the ink ejection state, or the like from preventing the normal ejection of the ink from the ejection ports 13. Also, setting the fixed coefficient within the range of 1.05 to 5, inclusive, will keep the output of the circulation pump 1002 from becoming excessively high and therefore lengthen the life of the circulation pump 1002.

In step S409, the setting unit 152 of the control unit 50 performs a process of writing information on the minimum output Pth, with which the ink can be normally ejected from the ejection ports 13, to the storage element of the liquid ejection head 3, and the processing ends. Note that the output Pr of the circulation pump 1002 stored in the storage element of the liquid ejection head 3 is overwritten to the minimum output Pth derived in the current adjustment, with which the ink can be normally ejected from the ejection ports 13. Also, the setting unit 152 may store the information on Pth in another storage region in the storage element instead of overwriting it. In this way, it is possible to predict the newest minimum output Pth by analyzing the trend of Pth and thereby shorten the time it takes for adjustment of the inkjet printing apparatus 1.

As described above, according to the fourth embodiment, it is possible to perform proper ink (liquid) circulation while also allowing downsizing of the liquid ejection head 3, as in the first embodiment.

Also, the evaluation unit 151 evaluates whether the ink ejection state is such that the ink is normally ejected from the ejection ports 13 based on the detection signal sent from the optical sensor 402. In this way, no print medium is required, so that the ink ejection state is evaluated more simply and easily. In the evaluation of the ink ejection state, the liquid ejection head 3 may eject the ink into a cap (not illustrated) that covers the tip of the liquid ejection head 3 to prevent drying of the ink from the ejection ports 13, since printing on a print medium is not required.

Also, the evaluation unit 151 is capable of detecting the minimum output Pth of the circulation pump 1002, with which the ink can be normally ejected from the ejection ports 13, in a short period of time based on the information on the output Pr of the circulation pump 1002 stored in the storage element of the liquid ejection head 3. This shortens the time it takes for adjustment of the inkjet printing apparatus 1.

Note that the present embodiment is not limited to serial-type printing apparatuses but is applicable also to line-type printing apparatuses, like the first embodiment.

In the above fourth embodiment, the evaluation unit 151 evaluates whether the ink ejection state is such that the ink is normally ejected from the ejection ports 13 based on the detection signal sent from the optical sensor 402, but the fourth embodiment is not limited to this. For example, as in the modification of the second embodiment, the evaluation unit 151 may evaluate whether the ink ejection state is such that the ink is normally ejected from the ejection ports 13 based on the detection signals sent from the temperature detection elements 905. As in the first embodiment, the evaluation unit 151 may evaluate whether the ink ejection state is such that the ink is normally ejected from the ejection ports 13 in the liquid ejection head 3 based on the evaluation pattern PTN read by the scanner 63. In this case, the evaluation unit 151 may evaluate the ink ejection state after printing all evaluation patterns PTN with the output of the circulation pump 1002 varied. This makes it possible to evaluate the ink ejection state in a short period of time.

In the above fourth embodiment, the evaluation unit 151 increases the output Pa of the circulation pump 1002 by the fixed value n from Pr-m, but the fourth embodiment is not limited to this. For example, the evaluation unit 151 may decrease the output Pa of the circulation pump 1002 by the fixed value n from the maximum output Pmax settable for the circulation pump 1002. In this way, the ink ejection state will be such that the ink will be normally ejected from the ejection ports 13 from the beginning. This will prevent the viscosity of the ink in the ejection ports 13 from rising before detecting the minimum ink circulatory flow velocity Vth (and Pth), with which the ink can be normally ejected from the ejection ports 13. Accordingly, the detected minimum ink circulatory flow velocity Vth and minimum output Pth will be less likely to vary.

In each of the embodiments described above, the inkjet printing apparatus includes the thermal-type liquid ejection heads 3 having the heaters 15 as ejection elements, but the embodiment is not limited to this. For example, the inkjet printing apparatus may include piezoelectric-type liquid ejection heads having piezoelectric elements as ejection elements.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-031812, filed Mar. 4, 2024, which is hereby incorporated by reference wherein in its entirety.

What is claimed is:

1. A liquid ejection apparatus comprising:
a liquid ejection head having an ejection port and an ejection element configured to eject a liquid from the ejection port;
a circulation pump configured to circulate the liquid to be supplied to the ejection port;
an evaluation unit configured to change an output of the circulation pump and evaluate an ejection state in which the liquid is ejected from the ejection port by the ejection element; and
a setting unit configured to set the output of the circulation pump based on a result of the evaluation of the ejection state by the evaluation unit.

2. The liquid ejection apparatus according to claim 1, wherein the evaluation unit evaluates the ejection state based on an evaluation pattern printed on a print medium by ejecting the liquid from the ejection port.

3. The liquid ejection apparatus according to claim 2, further comprising a scanner configured to read the evaluation pattern printed on the print medium, wherein
the evaluation unit evaluates the ejection state based on the evaluation pattern read by the scanner.

4. The liquid ejection apparatus according to claim 1, further comprising an optical sensor configured to detect a droplet ejected from the ejection port, wherein
the evaluation unit evaluates the ejection state based on a result of the detection of the droplet by the optical sensor.

5. The liquid ejection apparatus according to claim 1, wherein
the liquid ejection head has a temperature detection element provided for the ejection element, and
the evaluation unit evaluate the ejection state based on a temperature detected by the temperature detection element.

6. The liquid ejection apparatus according to claim 1, wherein the evaluation unit evaluates whether the ejection state is such that the liquid is normally ejected from the ejection port.

7. The liquid ejection apparatus according to claim 6, wherein the setting unit sets the output of the circulation pump to an output with which the liquid can be normally ejected from the ejection port based on a result of the evaluation of the ejection state by the evaluation unit.

8. The liquid ejection apparatus according to claim 7, wherein the output with which the liquid can be normally ejected from the ejection port is derived by multiplying a minimum output of the circulation pump with which the liquid can be normally ejected from the ejection port by a fixed coefficient.

9. The liquid ejection apparatus according to claim 8, wherein the fixed coefficient is set within a range of 1.05 to 5, inclusive.

10. The liquid ejection apparatus according to claim 1, wherein the evaluation unit changes the output of the circulation pump based on information on an output of the circulation pump stored in a storage element.

11. An adjustment method for a liquid ejection apparatus including
a liquid ejection head having an ejection port and an ejection element configured to eject a liquid from the ejection port, and
a circulation pump configured to circulate the liquid to be supplied to the ejection port,
the adjustment method comprising:
changing an output of the circulation pump and evaluating an ejection state in which the liquid is ejected from the ejection port by the ejection element; and
setting the output of the circulation pump based on a result of the evaluation of the ejection state.

12. The adjustment method for a liquid ejection apparatus according to claim 11, wherein the evaluating an ejection state includes evaluating whether the ejection state is such that the liquid is normally ejected from the ejection port.

13. The adjustment method for a liquid ejection apparatus according to claim 12, wherein the evaluating an ejection state includes, in a case of evaluating that the ejection state is not such that the liquid is normally ejected from the ejection port, changing the output of the circulation pump to a higher output and then evaluating again whether the ejection state is such that the liquid is normally ejected from the ejection port.

14. The adjustment method for a liquid ejection apparatus according to claim 12, wherein the evaluating an ejection state includes, in a case of evaluating that the ejection state is such that the liquid is normally ejected from the ejection port, changing the output of the circulation pump to a lower output and then evaluating again whether the ejection state is such that the liquid is normally ejected from the ejection port.
